(19) United States
(12) Patent Application Publication
(10) Pub. No.: US 2011/0099126 A1
(43) Pub. Date: Apr. 28, 2011

(54) Automated Parking Policy Enforcement System

(75) Inventors: Eshwar Belani, San Jose, CA (US); Santosh Godbole, Bangalore (IN); Mala Rangarajan, Bangalore (IN); Samuel Rajasingh, Chennai (IN); Sushil Siddesh, Bangalore (IN); Harish Prabhu, Trichy (IN); Neha Jain, Sunnyvale, CA (US)

(73) Assignee: SENSACT APPLICATIONS, INC., San Jose, CA (US)

(21) Appl. No.: 11/468,724

(22) Filed: Aug. 30, 2006

Related U.S. Application Data
(60) Provisional application No. 60/596,089, filed on Aug. 30, 2005.

(51) Int. Cl. G06F 17/00; B60Q 1/48

(52) U.S. Cl. 705/418; 340/932.2

(57) ABSTRACT

A parking policy management system helps identify and enforce parking violations in real-time. By monitoring sensors distributed in a parking area, the system will determine whether one or more parking policies have been violated. The types of parking policies the system can monitor include duration, time of day, unauthorized vehicle, special permit parking, and paid parking. When a violation of a policy is detected, a notification may be delivered to enforcement personnel through the Internet, personal digital assistants (PDAs), cell phones, in-vehicle dashboards, and other means.

### CROSS-REFERENCE TO RELATED APPLICATION

This patent application claims the benefit of U.S. provisional patent application 60/596,089, filed Aug. 30, 2005. This provisional application and all references cited in this application are incorporated by reference.

A portion of the disclosure of this patent document contains material which is subject to copyright protection. The copyright owner has no objection to the facsimile reproduction by anyone of the patent document or the patent disclosure, as it appears in the U.S. Patent and Trademark Office patent file or records, but otherwise reserves all copyright rights whatsoever.

### BACKGROUND OF THE INVENTION

The invention relates to parking management and parking policy enforcement and, more specifically, provides a system for automatically detecting parking policy violations.

As the places people live become more and more crowded, parking for automobiles become a much more important resource to manage efficiently and effectively. Moreover, in today's fast-paced and highly competitive environment, it is imperative for parking facility owners to ensure a seamless and enjoyable experience for each visitor. For example, in large cities such as New York, Chicago, San Francisco, Beijing, Shanghai, Tokyo, Seoul, London, Paris, Rome, and Berlin, and many other urban areas, regulating and managing parking are big challenges and it is becoming increasingly difficult to find available parking. Even when available parking spaces exist, visitors often have to circle around to find them. This leads to a waste of the visitors' time, increased pollution, increased use of fuel, and increased visitor stress and frustration. Additionally, not effectively enforcing parking rules and regulations results in inefficient use of parking spaces and a loss of revenues.

A parking guidance system provides visitors with information on where the available parking spaces are located. However, past approaches to building parking guidance systems have various limitations. The currently available systems are not accurate. Systems that are unable to consistently detect the presence of a vehicle in each parking space do not provide reliable guidance information. The current systems are also prohibitively expensive and cumbersome to install. Systems that use wires or cables to sense the presence of vehicles in parking spaces are very expensive. Additionally, these systems take a long time to install because they require an extensive wired infrastructure and it is very cumbersome to retrofit such systems in existing parking facilities.

Today's parking enforcement systems are not able to automatically detect parking violations. Currently, parking enforcement personnel typically circulate within parking zones repetitively to inspect whether the parked vehicles are in violation of any parking policies. Additionally, some parking facilities are large and widespread, and require multiple employees to monitor the parking spaces effectively. Automated detection of parking violations and quick notification to parking enforcement personnel eliminates the time and effort spent in manually scanning parking spaces to identify the vehicles in violation.

At other parking zones, such as city-street parking, there are periodic manual inspections by parking enforcement officers to enforce parking policies. For example, marking tires with chalk is one traditional method of time limit enforcement. Immediately after the tire is marked, the enforcement officer records the time and location of the vehicle. The enforcement officer returns to check the tires after the permitted time. Vehicles that are still in the parking spaces are ticketed for exceeding the time limit. Also, commuters often continue to park in spaces after the meter expires. It is observed that coin totals from parking meters are often much less than what should be collected from actual parking activity.

The available parking revenue management systems result in a cumbersome experience for the commuter and provide limited audit capabilities. Current parking operation systems cannot correlate the parking transaction information with the actual physical parking activity occurring at the parking facilities.

Detecting parking violations using the existing methods is labor intensive. However, despite the resources spent on parking enforcement, a large percentage of violations still remain undetected. This results in a loss of revenue from fines, and/or leading to an inequitable utilization of the parking spaces. An automated parking enforcement system eliminates human involvement in detecting violations, allows for accurate and timely citations, and improves the overall efficiency of parking enforcement.

Additionally, the difficulty of finding parking spaces at public attractions and forums may induce commuters to violate parking policies by parking in restricted spots such as tow-away, loading, or no-parking zones. Sometimes commuters are tempted to park closer to their destination by parking in unmarked spaces, impeding vehicular or pedestrian traffic movement. When commuters park in areas that are not designated as valid parking spaces, it makes it difficult for other commuters to freely occupy or leave their designated parking spaces.

Moreover, parking regulation and policies are designed for the safety and convenience of the public. For example, vehicles illegally parked in restricted spaces assigned to emergency vehicles, such as fire lanes, may constitute a hazard. Similarly, unauthorized vehicles parked along loading zones impede tasks for making essential repairs and deliveries. In cases where commuters park longer than the allowed parking duration leads to an inequitable use of the parking spaces. Such offenders should be fined or towed to reduce the hazards of parking in a congested lot and to discourage them from violating parking policies in future. Given the challenges associated with parking enforcement today, public parking officials estimate that the citations issued only account for a small percentage of actual violations.

Therefore, there is a need for an improved parking policy enforcement system.

### BRIEF SUMMARY OF THE INVENTION

A parking policy management system helps identify and enforce parking violations in real-time. By monitoring sensors distributed in a parking area, the system will determine whether one or more parking policies have been violated. The types of parking policies the system can monitor include duration, time of day, unauthorized vehicle, special permit parking, and paid parking. When a violation of a policy is detected, a notification may be delivered to enforcement personnel through the Internet, personal digital assistants (PDAs), cell phones, in-vehicle dashboards, and other means.

A goal of a parking enforcement module is to detect violations of parking policies and send alerts to parking enforcement personnel to take appropriate action. The enforcement system helps parking operations managers to optimally enforce parking policies and ensure the equitable and uniform use of parking spaces.

An implementation of the invention includes technology to detect the arrival of a vehicle in a parking space, provide continuous monitoring of the parked vehicle, and report any violation of parking policies. An alert e-mail or SMS message could be sent to a handheld device or can be highlighted as an alarm on a desktop based computer when there is a violation. A specific implementation of a parking enforcement module is known as SimplyPark Enforcement™, which is made by Sensact Applications, Incorporated.

Parking violation alert messages in the automated enforcement system are quick, accurate, and easy to enforce. Some examples of parking policies that can be enforced by the system include: restricted or no-parking zones; no parking or limited parking in loading/unloading zones; no double parking; paid parking enforcement; time-of-the day parking restrictions, such as no parking between 2 a.m.-8 a.m.; duration-based parking restrictions, such as two-hour parking only; and special permit parking restrictions, such as handicap permit required.

Parking revenue and citation fees are vital for private parking facilities and important for municipalities to build better amenities and subsidize taxes. An automated system helps reduce the number of enforcement officers required for parking enforcement. Fewer parking enforcement officers are required to issue tickets to parking violators when a system can generate automated violation alerts. Since all parking violations are detected and recorded, parking management personnel can tally the citation revenue actually collected with the total revenue computed based on violations detected. Additionally, the recorded data help parking management personnel to determine the effectiveness of each parking enforcement officer.

An implementation of the invention can be integrated with parking revenue management systems (e.g., parking meters, cell phone based payment systems, pay-by-space machines) to raise paid parking violation alerts when visitors fail to pay or overstay their paid parking duration. These alerts could be transmitted to the enforcement personnel without them having to manually inspect the status of each parking space. Additionally, one implementation of the invention can be integrated with parking revenue control equipment to audit the parking revenues collected based on actual physical parking activities in a parking facility.

In one implementation of the invention, the enforcement system automatically authenticates valid users of handicap or special parking spaces and detects parking violators. Parking enforcement personnel need not manually inspect special permits or placards. The enforcement system notifies the enforcement personnel via alerts on their handheld devices or at a monitoring console in an office. The alerts contain information about the nature of parking violation as well as the location of the parking space where violation occurred.

An implementation of the invention supports parking policies that encourage a quick turnover of vehicles in parking spaces and ensures equitable use of parking spaces. For example, an owner of a coffee shop with a limited number of parking spaces may restrict the parking duration for those spaces. The shop owner could receive an alert when a vehicle is parked for more than the stipulated duration. In this way, the shop owner is able to accommodate a larger number of customers since the likelihood of an available space for an incoming customer will increase. The shop owner may also be able to attract customers who would otherwise be deterred from visiting the shop due to shortage of parking spaces.

In summary, the automated parking enforcement system could help increase the effectiveness of parking operations. Some of the system's benefits include: automated parking violation detection and notification, minimal human intervention, parking enforcement officer performance review, paid parking based alerts and parking revenue audit, and fair distribution of limited parking spaces among customers.

The parking enforcement system of the invention may also include a parking guidance component. A more detailed discussion on a parking guidance component is presented in U.S. patent application Ser. No. 11/468,722, filed Aug. 30, 2006, which is incorporated by reference. Furthermore, there may be also a parking activity analysis module to provide detailed records on parking activity that could be used for a variety of purposes, such as auditing the parking revenue collected.

In short, a parking guidance system tracks available parking spaces and leads users to vacant spots through display boards placed at strategic locations in the parking lot. Sensor nodes are deployed at parking spaces or within traffic lanes to monitor parking space occupancy and wirelessly transmit this information. The sensor nodes form a wireless network that routes the knowledge of available spaces to the corresponding display boards and updates them in real time. Parking availability information may also be shared with users in a variety of other ways.

In an embodiment, the design and development of sensor node hardware is affordable, energy efficient, and produces accurate readings. The hardware is robust, easy to install, and can be camouflaged within the infrastructure. The invention provides quick and accurate updates to display boards to direct traffic towards vacant spots. The embedded software improves the battery life of sensor node hardware, as well as reliability and response time of the system. User-friendly, front-end tools are available for real-time monitoring, maintenance, and remote management of the parking facilities.

A system of the current invention has numerous advantages. First, the system provides for parking policies enforcement and parking guidance. Second, the system is designed based on a scalable and modular system architecture that can be easily customized to the varying requirements of different types and sizes of parking lot facilities. Third, the system has a self-healing feature that identifies anomalies and malfunctions at run-time and repairs the faults without affecting its on-going operation.

In an embodiment, the system is scalable to meet the needs of networks containing thousands of nodes. The system has extremely robust peer to peer network that is self-healing. It is easy to deploy, self-configurable, and low maintenance. It has a low duty-cycle and intelligent in-network processing, intuitive multiplatform front-end graphical user interface, and bidirectional routing for command and control.

In an embodiment, the system may be used with indoor or outdoor parking, or combinations of these two. The technology is resistant to external factors such as weather conditions. The technology is affordable. The system may be wireless so it may be deployed in open infrastructures where it is impossible to install wires or lack power sources. The system provides accurate estimates of the available parking spaces and generates comprehensive reports of real-time and historical parking activity.

In an embodiment, the invention is a method including: providing a number of parking spaces in a first parking area; providing a number of sensors to detect whether each parking space in the first parking area is occupied or unoccupied; providing an enforcement policy for each parking space in the first area; and based on data received from the number of sensors, determining whether an enforcement policy of a parking space is violated.

The method may further include when the enforcement policy if violated, sending a notification to a device. The method may include specifying an enforcement policy for each parking space. When the enforcement policy if violated, the method may include charging a fee to account associated with the vehicle violating the enforcement policy. The enforcement policy for each parking space may be different. A first enforcement policy for a first parking space is different from a second enforcement policy for a second parking space. The sensors wirelessly detects whether a parking space is occupied.

An enforcement policy may be is violated when a parking space is occupied for more than a specified elapsed time period. An enforcement policy may be violated when a nonparking space area is occupied for more than a specified elapsed time period. An enforcement policy may be violated when two or more parking spaces are occupied by a single vehicle for more than a specified elapsed time period. An enforcement policy may be violated when a parking space is occupied during a prohibited time period. An enforcement policy may be violated when a parking space is occupied by an unauthorized vehicle. An enforcement policy may be violated when a parking space is occupied and a parking meter associated with the parking space has expired. The enforcement policy may include that the parking space is occupied during an enforcement time period of the parking meter. The enforcement policy may include that the parking space is occupied during an enforcement time period of the parking meter.

Multiple enforcement policies may apply to one or more spaces. In the case of multiple policies applying, there may be a priority scheme to determine which policy takes precedence. Each enforcement policy may be assigned a priority value. For example, this may be a numerical value. Then the enforcement policy with the higher priority value (or in alternative embodiment, lower priority value) will be give priority over a enforcement policy having a lower priority value.

Other objects, features, and advantages of the present invention will become apparent upon consideration of the following detailed description and the accompanying drawings, in which like reference designations represent like features throughout the figures.

### BRIEF DESCRIPTION OF THE DRAWINGS

FIG. 1 shows the functional components of the system.

FIG. 2 shows the system architecture.

FIG. 3A shows a computer system which may be used in the implementation of a parking policy enforcement system of the invention.

FIG. 3B shows a system block diagram of the computer system.

FIG. 4A shows a board design of a sensor node.

FIG. 4B shows the sensor node hardware.

FIG. 5 shows the sensor node software design.

FIG. 6A shows a ferrous object causing a disturbance in a uniform magnetic field.

FIGS. 6B and 6C show how the sensor node compensates for drifts in its magnetic readings.

FIG. 7A shows one parking layout with magnetic sensors detecting space occupancy.

FIG. 7B shows another parking layout with magnetic sensors detecting space occupancy.

FIG. 7C shows another parking layout with magnetic sensors detecting space occupancy.

FIG. 8 shows the board design of a permit node.

FIG. 9 shows permit node software design.

FIG. 10 shows a bridge node hardware design.

FIG. 11 hierarchical organization of the network topology.

FIG. 12 shows the bridge node software design.

FIG. 13 shows a timing diagram for media access control (MAC) frames.

FIG. 14 shows a monitoring console screen displaying the real-time occupancy status of each parking space in a facility

FIG. 15 shows the central server design.

### DETAILED DESCRIPTION OF THE INVENTION

A system of the invention retrieves parking occupancy information from parking space sensors, identifies available parking spaces, disseminates parking availability information to commuters, detects any parking policy violations, creates parking violation alerts and disseminates them to appropriate alert devices. Alert devices could be a monitoring console viewed by parking facilities management staff or handheld devices such as PDA, cell phone, or pager carried by parking enforcement personnel. Alert devices could also include other systems that accept the alerts via an integration application programming interface (API). Administration and management tools are vital to make sure that the functional components are performing correctly.

Functional Overview

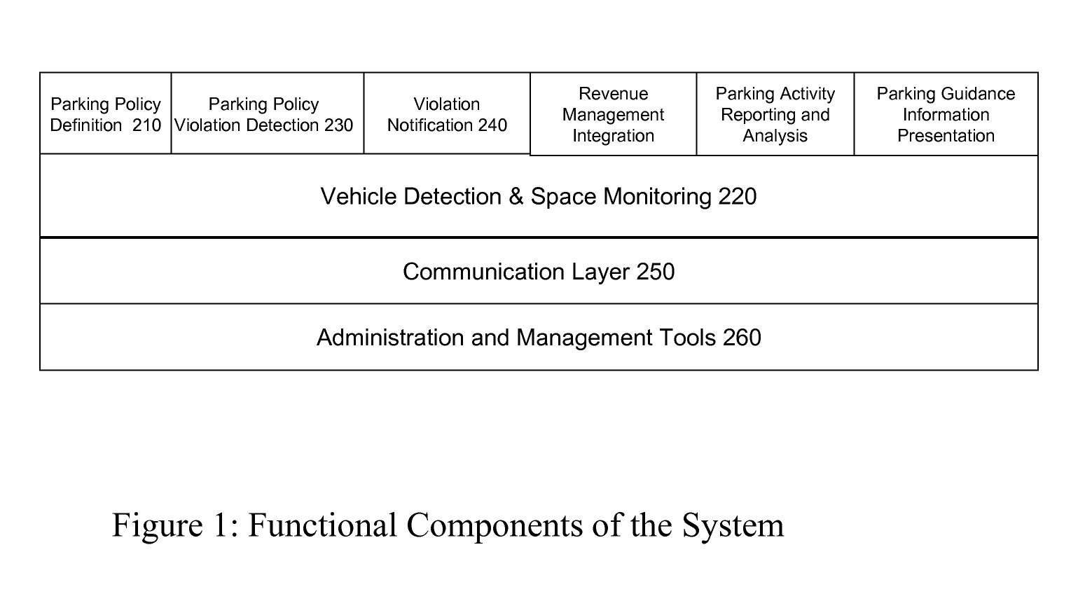

FIG. 1 shows the functional components of the system. The components of the system include parking policy definition 210, vehicle detection and parking space monitoring 220, parking policy violation detection 230, violation notification 240, parking revenue management system integration, parking activity reporting and analysis, parking guidance information presentation, communication layer 250, and an administration and management tools layer 260. Further components include revenue management integration, parking activity reporting and analysis, and parking guidance information presentation.

Parking administrators define parking policies in the parking policy definition component 210. The vehicle detection and parking space monitoring component 220 helps identify the occupancy status of parking spaces. The parking policy violation detection component 230 tracks the parking space identifier and location of each space, the time of arrival of the vehicle, the duration of the vehicle's space occupancy, and the vehicle's parking credentials in the case of permit based parking. The parking policy violation notification and reporting component 240 disseminates violation alerts to the central server as well as any portable devices carried by the parking enforcement officers.

The revenue management integration component exchanges messages with a parking revenue control system that helps detect paid parking based alerts as well as audit parking revenue collected. The parking activity reporting and analysis component provides real-time as well as historical reports on a variety of parking activity metrics. The parking guidance information presentation component communicates the guidance information via appropriate visual displays as well as over the Internet.

A system of the invention may have a greater number or a fewer number of functional components than described. The system has nine functional components. Other systems may have one, two, three, four, or five components, or more than nine components, such as ten, or eleven. Two or more functional components may be combined into a single functional component, or a functional component may be divided into multiple functional components, or any combination of these. For example, the parking policy definition component may be combined with the vehicle detection and parking space monitoring component. Each functional component may include any number of subcomponents. A specific implementation of a system is known as SimplyPark™, which is made by Sensact Applications, Incorporated.

In one implementation, an administrator may associate zero or more parking policies with each parking space or zone in the parking policy definition component at set up time. The types of policies that can be defined include, but not limited to, the following: time of the day restrictions; no parking at anytime; no parking between 2 a.m. and 8 a.m.; duration restrictions; 30 minute parking; 2 hour parking; permit restrictions; handicapped reserved parking; permit “A” reserved parking; paid parking restrictions; and visitor must pay for the duration they park their vehicle.

Additionally, parking administrators may define a grace time period after which a policy should be enforced and whether a policy could be consecutively enforced on a violating vehicle. If a parking policy is violated, an alert is sent out. The parking administrator can also define which parking enforcement officer (or officers) should receive the parking alert for a given parking space at any given time. In general, an alert may be issued to one or more enforcement officers based on variety of factors including, but not limited to, the following: location of parking space where a violation has occurred; type of violation; time of violation; workload of the parking enforcement officer; location of the parking enforcement officer; past history of alerts issued to the parking enforcement officer; and performance of the parking enforcement officer.

The vehicle detection and parking space monitoring component can be designed using a variety of sensor technologies such as ultrasonic sensors, magnetometers, or cameras. There are many types of sensors that may be used to detect a passing vehicle or whether a vehicle is present at a particular location, and any of these sensors may be used in a system of the invention. A sensor may use a combination of technologies in its detection technique. For example, a sensor may use ultrasonic and magnetic detection technologies. Some examples of sensor technologies include electromagnetic wave or impulse, laser, optical, infrared, acoustic, physical or mechanical switch, sound, temperature, and pressure. These sensors may communicate their information wirelessly.

Ultrasonic sensors are typically installed on the ceilings of individual parking spaces in indoor parking lots. These sensors periodically measure the distance from the sensor's location to the ground level using ultrasonic rays and are calibrated with the known distance between the sensor and the ground level. If the ultrasonic sensors discover that the measured distance of the ground from the sensor's location is less than the calibrated distance, they infer a car to be parked at the parking spot. In addition to ceilings, ultrasonic sensors may also be mounted on the ground or floor, or on a vertical or side wall.

Cameras can be used to capture images of parking spaces in real time to detect any car coming or leaving the parking space. Different cameras may be positioned to capture different views of the parking spaces and later images from different cameras may be combined to decide whether a vehicle was observed to be leaving or arriving in a parking space.

Magnetic sensors are another kind of sensor that could be installed at the parking space to measure the disturbance in earth's magnetic field cause due to a vehicle parked at the parking space. Since the engine of most vehicles is made of ferrous alloys, there is noticeable change in the earth's magnetic field due to their presence. This change in the magnetic field detected by the magnetic sensor is sufficient to detect the arrival or departure of a vehicle from the parking space.

In addition to using a specific sensor node to track one or more parking spaces, the system could leverage one or more sensor nodes in a collaborative fashion to determine the availability of a set of parking spaces. Information from these different sensor nodes may be processed in a distributed fashion to reinforce observations as well as eliminate false negative or false positive observations. In one implementation, the use of wireless communication saves significant costs that would otherwise arise from laying communication cables. Moreover, the use of wireless communication rapidly facilitates the deployment of the application to parking facilities of any scale and varying civil structures or architecture, for example indoor or outdoor facilities, inclined ramps, multilevel facilities, basements, or street parking.

In an implementation, the system may include permit nodes installed on vehicles, enabling automated verification of vehicle credentials for parking in permit based spaces. This eliminates the need to manually inspect placards or special permits installed on vehicles. There are a variety of permit nodes. For example, electronic microcontroller based devices can store permit credentials and serve as permit nodes. These permit nodes may wirelessly exchange their credentials with another node in the parking facility that is authorized to read and verify the permit node contents. Another example of a permit node is a color coded tag pattern that is affixed onto the exterior of the vehicle. The color coded tag could be visually scanned by a camera based sensor and the information transmitted wirelessly to a receiving node.

In one implementation the parking policy violation detection component tracks the following parameters for each parking space:

(1) Parking space identifier and location.

(2) Time of arrival of vehicle.

(3) Duration of the vehicle's parking occupancy.

(4) Identifying vehicle credentials (only for permit based parking spaces).

(5) Payment status (for paid parking based enforcement).

The system then continuously evaluates parking policies associated with the space to identify any parking violation. Multiple parking policies can be applied to a single parking space and each policy is evaluated to detect any parking violation occurring at that space.

In other implementations, the parking policy violation detection component may track fewer parameters. In yet other implementations, the component may track additional parameters.

In an implementation, the parking policy violation notification and reporting component disseminates violation alerts to a central server as well as any portable devices carried by the parking enforcement officers. These portable devices may be personal digital assistants (PDAs), smart phones, pagers, cellular phones, dashboards of vehicles used by the parking enforcement officers, notebook computers or laptops, desktops, or any other handheld or portable devices. Additionally, the parking officer can map the parking space identifier in the alert to its location in the parking zone using a browser based map of the facility to view where the violation occurred.

Alerts are qualified by a set of parameters such as the parking space identifier, type of parking policy violation, and the time stamp. These parameters are sent to the parking enforcement officer notifying him or her of the violation. The system administrator may assign certain parking zones in a parking facility to a specific parking enforcement officer. The appropriate parking enforcement person to receive an alert is identified based on a set of factors that include the specific parking space and time of the violation. A notification is then disseminated to the handheld alert device carried by the parking enforcement officer. A central server also records these events for the parking management staff and the data are readily accessible from a monitoring console. The parking policy violation alerts can also be sent to another system which receives them based on a software API.

Alerts are typically issued if the violation persists beyond a specific grace period. For example, if a violator fails to remove his illegally parked vehicle during the five minute grace period for a two-hour limit parking space, an alert is issued to notify the appropriate parking enforcement officer. After a parking enforcement officer receives an alert, it may take some time before he or she reaches the location of the violation. Once the parking enforcement officer reaches the space, the enforcement officer can query the system to verify that the automobile currently in the space violated a parking policy. If the violating vehicle leaves the parking space before the enforcement officer reaches the parking space, the system sends the enforcement office a violation termination alert indicating that there is no current violation at the space. Additionally, after an enforcement officer cites a vehicle, he sends a citation message to the system indicating that he has enforced the parking violation. If the enforcement alert for that violation was sent to multiple enforcement officers, the other officers will receive a violation citation alert indicating that the violation has already been enforced.

In one implementation, the system supports browser-based views at monitoring consoles to show current or past parking violations. The browser shows elaborate views of the entire parking lot layout with parking spaces marked on them showing the current violations occurring in real-time or past parking violation statistics. Additional parameters, such as the time that has elapsed since a car was parked in a particular space, may be added to augment these views. Historical information related to violations is important for analyzing the effectiveness of the enforcement personnel by observing trends in parking violations incidents and the actual citations issued with time. Access privileges are assigned to authorized parking facilities personnel for accessing these views on the monitoring consoles. Analysis of parking activity at parking spaces and associated policies that are violated more often than others can lead to a better understanding of commuter behavior and utilization patterns of the parking facility. Additionally, new parking policies may be defined based on this understanding to facilitate the fair, safe, and equitable use of parking facilities. For example, a few five minute parking spaces close to the add/drop box of a library may prevent parking in unmarked areas for a quick trip to drop books at the library.

The communication requirements from the network include routing data from sensor nodes deployed at parking spaces to the entity computing alerts, routing credential information from permit nodes to the entity computing alerts, routing information from a parking revenue control system to the entity computing alerts, and routing of alert messages from the entity generating alerts to the various monitoring consoles and the alert devices carried by parking enforcement officers. Although a wired network or a combination network containing both wired and wireless elements could fulfill the communication requirements, a pure wireless network is usually more cost effective and more versatile. A wireless network enables the seamless deployment of the system to different types of parking facilities, such as lot-based parking garages, outdoor or indoor parking facilities at shopping malls, theme parks, movie theaters, airports or street parking in downtown, residential areas.

The wireless network is comprised of multiple entities that need to communicate with each other. These entities include sensors, processors, routers, and sinks. The sensors produce the data. The processors compute the data. The routers transfer the data to the sinks, and the sinks consume the data. The entities may reside on different physical computing elements or may be combined together on the same computing element.

The communication within the network can be categorized into two categories: application and infrastructure. Application communication refers to the transfer of parking space occupancy, payment, and vehicle permit data, to the sinks. Infrastructure communication refers to the communication needed to configure, maintain and optimize network operations. More specifically, because of the ad hoc nature of wireless networks, the data routing nodes must be able to discover paths to the sinks. Thus, infrastructure communication is necessary to keep the network functional, ensure robust operation in dynamic environments, and optimize overall performance of the network.

There are a variety of network topologies possible depending on how the entities are deployed, the wireless technology chosen to connect them, cost of network installation, and the design complexity of the communication architecture. Diverse wireless technologies could be used to form a heterogeneous network. The network may be a pure wireless network or a combination of a wired and wireless network. Some examples of network topologies include single hop network, heterogeneous hierarchical network, and multihop mesh network.

In a single-hop network, all of the entities can directly communicate with each other using Wi-Fi, Ethernet, or long range radio links such as WiMAX.

In a heterogeneous hierarchical network topology, the entities are connected by single or multiple hops to each other. The routers play a key role within the network to facilitate the exchange of messages via multiple hops. Different network hops could utilize different communication technologies. For example, the processors could use low power, short range links, such as Institute of Electrical and Electronics Engineers (IEEE) 802.15.4, or Bluetooth wireless technology to communicate with the routers. The routers in turn may use technologies such as IEEE 802.11 or WiMAX to communicate with sinks.

A multihop mesh network comprises of a network of nodes that contain sensors, processors, as well as routers and form a peer-to-peer ad-hoc wireless network as well as generate events related to vehicle detection. The nodes in this topology forward their own data as well as their neighbors' data to the sinks. If the destination nodes are outside of the source node's radio range, the source uses intermediate nodes to forward data to the destination nodes. A network is dense enough to have sufficient intermediate nodes to relay data between source destination pairs separated by multiple hops. Depending on network density, average node separation, and expected data rate, the network may use low power IEEE 802.15.4, Bluetooth wireless technology, long range IEEE 802.11 links, or other technologies, to form the mesh network.

Computation of alerts can be performed at sensor nodes, router nodes, or at a remote server situated at one end of the wireless network. If detection of violations occurs at the sensor nodes, then either a single-hop network, a heterogeneous hierarchical network topology, or a multihop mesh network could relay alert notifications to the alert devices. If alerts are computed at the middle tier of the hierarchical network, then inputs from sensor nodes, payment nodes, and permit nodes are forwarded to the core network of routers. The routers compute the alerts and forward the alerts to alert devices. In another communication architecture, all vehicle occupancy, payment, and permit data are transferred to a server (i.e., sink) via a sensor mesh network or a hierarchical router network. The server interfaces with the wireless network through gateway nodes deployed in different parking zones. A gateway node collects vehicle occupancy and permits data from its parking zone and transmits the data to the server. The payment related data may reach the server either via a wireless network or a wired one. The server then processes the data, computes the alerts, and transmits the alerts to alert devices.

In other implementations of the invention, the network entities may be combined. For example, the sensor nodes may be combined with the router nodes into one entity that is capable of performing the functions of both types of nodes. Alternatively, the individual entities may be further divided into separate entities.

The parking guidance information presentation component presents parking guidance information to end users via variable message signs or on the Internet. A variety of physical displays (e.g., LED, LCD, fiber optic based display) can be used to present real-time information to the visitor. Depending on the capability of the signs used, appropriate alphanumeric messages and symbols can be flashed on the display screen to guide the visitor to the closest available spot. For example, a sign may simply show the count of available spaces, and if all spaces are occupied, the display may flash the sign “FULL.” The displays may include dynamic signage as well as user friendly navigation facilities to visitors.

The displays may also be manually controlled via a server to present other custom information. For example, while some displays may show parking availability information, other displays may be manually overridden to show advertising messages, public safety messages, special event messages, or other information. Each sign may be easily configured via an intuitive web browser based interface, thus reducing the manual labor associated with parking zone control. This feature may also be leveraged to indicate fixed routes, special reservations, or parking area closures for maintenance work. For example, traffic control inspectors can streamline heavy traffic flow with the appropriate messages flashed on the displays.

In an implementation, the system may be set up with dynamic informational signage to guide visitors at key decision points along anticipated routes to an available parking space. For example, signs on a freeway or road can direct a visitor to the right entrance as they approach the parking facilities. Signs at the parking facility entrance can summarize availability within the facility. Overhead signs at each parking level or zone can indicate the number of spaces available in each aisle. There is no limitation on the number of guidance signs that are installed as part of a system deployment.

In an implementation, the system may take into account the number of circulating vehicles in the parking facility in addition to vehicles already occupying spaces in calculating an accurate number of available spaces. This is especially useful during busy hours when some parking zones are almost full and contain a fair amount of circulating traffic. The display boards can display both the actual and anticipated count of occupied spaces. The incoming traffic can automatically be directed to parking zones with a larger percentage of available spaces.

In an implementation, the guidance related data is sent to a central server and data repository. The software server makes the data available to end users via a browser based monitoring console. The console displays elaborate views of the entire parking lot. These views may include the parking lot layout with display locations showing their current available space counts and individual parking spaces showing their current occupancy status. The monitoring console may also be viewed from PDAs, or other devices by parking facilities personnel to review parking activity.

Administration and Management tools control, configure and manage the other functional components the automated enforcement system. Diagnostic or network management tools monitor network health and identify malfunctioning nodes. These tools include centralized or distributed views of the entire network topology to verify that nodes are well connected and that the deployment is dense enough to ensure end-to-end packet delivery in spite of unpredictable node or link failure. Diagnostic tools help detect network partitions and possible wireless interference. Some diagnostic tools include packet snooping and probe tools installed on PDAs to study network activities in a particular geographical region of the deployment to perform trouble shooting tasks. Network management tools may collect data related to residual energy level of the nodes if the nodes are battery powered so that the maintenance staff knows when to replace malfunctioning nodes or nodes with exhausted batteries. Additionally, the administrative tools may help with remotely upgrading the software code on all the entities in the system.

In other implementations of the invention, the administration and management tools may provide other data to help control, configure, and manage the functional components of the system.

System Architecture

The communication architecture for information dissemination varies depending on the choice of hardware, communication technology (i.e., wired or wireless), method of powering the nodes (i.e., line powered or battery operated nodes), and other deployment constraints.

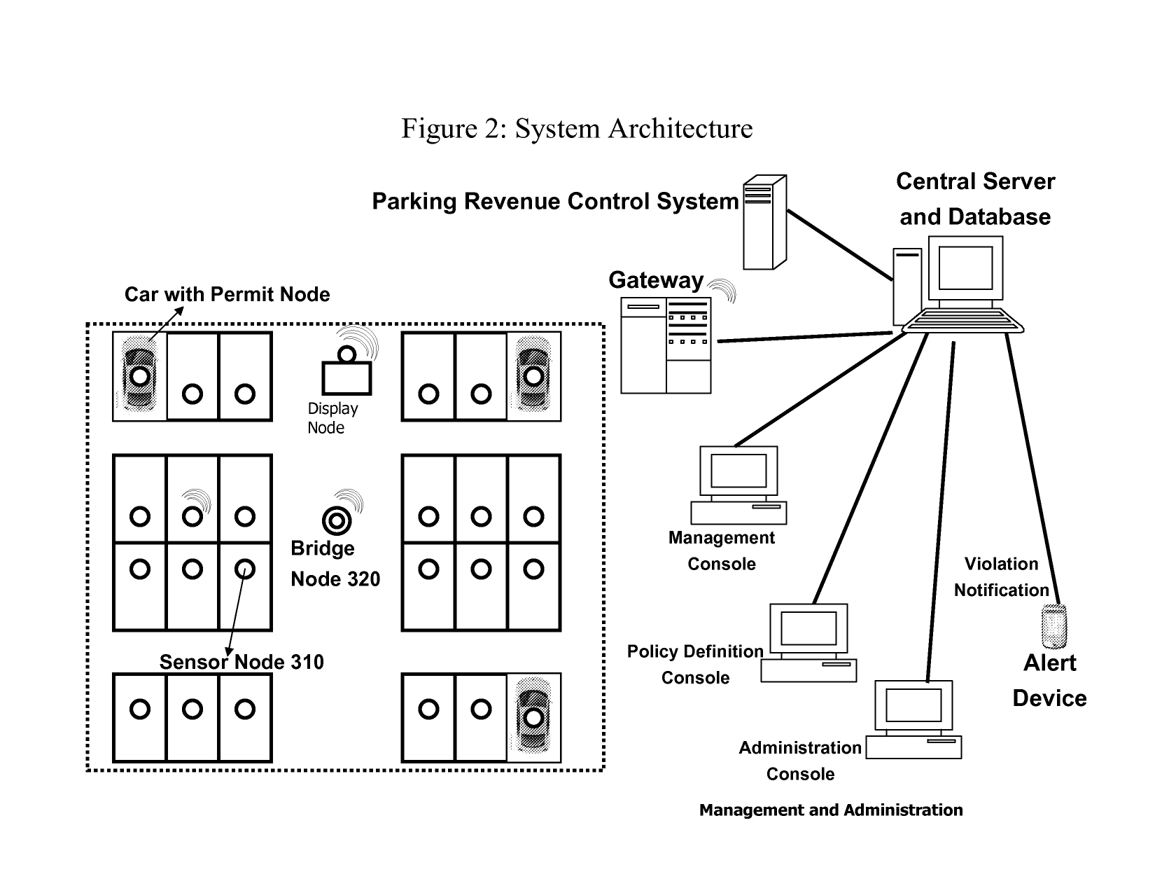

FIG. 2 illustrates the system architecture of the system. The entities shown include sensor nodes 310, which form an intelligent vehicle detection system 315, bridge nodes 320, permit nodes, display nodes, gateway nodes 335, parking revenue management system, and a management and administration system 340. In other implementations of the invention, any component may be split into multiple components or different components may be combined into a single component.

In a specific implementation, a management and administrative system may include a central server and database 345 (also know as a root node) which stores data collected from the wireless network of sensor nodes, bridge nodes, and permit nodes. The central server may host software to provide data to an administrative console 355 related to parking enforcement, administration, and network health and management.

Using the administrative console, a user may also monitor, manage, and administer parking activity. The central server may host software to also provide data into a monitoring console 360 or a violation alert device 365, or both of these. The central server may also host software that allows users to access a policy definition console to define the parking policies that need to be implemented in the system. The central server may also integrate with a parking revenue management system containing one or more payment nodes to get access to payment data.

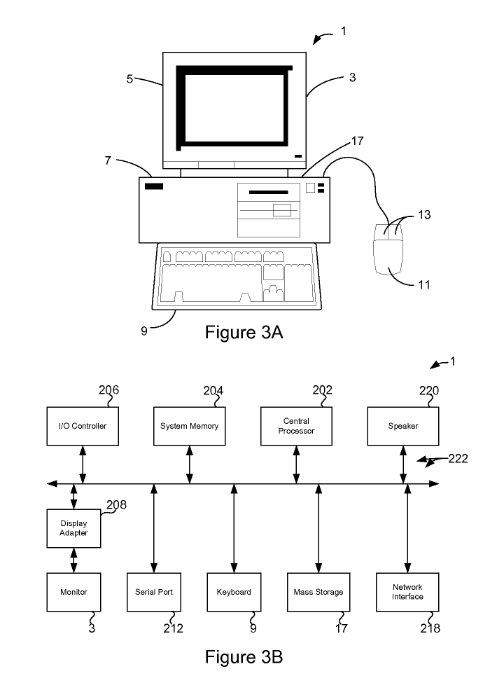

FIG. 3A shows a computer system 1 that includes a monitor 3, screen 5, cabinet 7, keyboard 9, and mouse 11. Such a computer system may used in the administration and operation of a parking system of the invention. Mouse 11 may have one or more buttons such as mouse buttons 13. Cabinet 7 houses familiar computer components, some of which are not shown, such as a processor, memory, mass storage devices 17, and the like.

Mass storage devices 17 may include mass disk drives, floppy disks, magnetic disks, optical disks, magneto-optical disks, fixed disks, hard disks, CD-ROMs, recordable CDs, DVDs, recordable DVDs (e.g., DVD-R, DVD+R, DVD-RW, DVD+RW, HD-DVD, or Blu-ray Disc), flash and other nonvolatile solid-state storage (e.g., USB flash drive), battery-backed-up volatile memory, tape storage, reader, and other similar media, and combinations of these.

A computer-implemented technique of the invention may be embodied using, stored on, or associated with computer-readable medium. A computer-readable medium may include any medium that participates in providing instructions to one or more processors for execution. Such a medium may take many forms including, but not limited to, nonvolatile, volatile, and transmission media. Nonvolatile media includes, for example, flash memory, or optical or magnetic disks. Volatile media includes static or dynamic memory, such as cache memory or RAM. Transmission media includes coaxial cables, copper wire, fiber optic lines, and wires arranged in a bus. Transmission media can also take the form of electromagnetic, radio frequency, acoustic, or light waves, such as those generated during radio wave and infrared data communications.

For example, a binary, machine-executable version, of the software of the present invention may be stored or reside in RAM or cache memory, or on mass storage device 17. The source code of the software of the present invention may also be stored or reside on mass storage device 17 (e.g., hard disk, magnetic disk, tape, or CD-ROM). As a further example, code of the invention may be transmitted via wires, radio waves, or through a network such as the Internet.

FIG. 3B shows a system block diagram of computer system 1 used to execute software of the present invention. As in FIG. 3A, computer system 1 includes monitor 3, keyboard 9, and mass storage devices 17. Computer system 1 further includes subsystems such as central processor 202, system memory 204, input/output (I/O) controller 206, display adapter 208, serial or universal serial bus (USB) port 212, network interface 218, and speaker 220. The invention may also be used with computer systems with additional or fewer subsystems. For example, a computer system could include more than one processor 202 (i.e., a multiprocessor system) or the system may include a cache memory.

The processor may be a dual core or multicore processor, where there are multiple processor cores on a single integrated circuit. The system may also be part of a distributed computing environment. In a distributed computing environment, individual computing systems are connected to a network and are available to lend computing resources to another system in the network as needed. The network may be an internal Ethernet network, Internet, or other network.

Arrows such as 222 represent the system bus architecture of computer system 1. However, these arrows are illustrative of any interconnection scheme serving to link the subsystems. For example, speaker 220 could be connected to the other subsystems through a port or have an internal connection to central processor 202. Computer system 1 shown in FIG. 3A is but an example of a computer system suitable for use with the present invention. Other configurations of subsystems suitable for use with the present invention will be readily apparent to one of ordinary skill in the art.

Computer software products may be written in any of various suitable programming languages, such as C, C++, C#, Pascal, Fortran, Perl, MatLab (from MathWorks, Inc.), SAS, SPSS, Java, JavaScript, and AJAX. The computer software product may be an independent application with data input and data display modules. Alternatively, the computer software products may be classes that may be instantiated as distributed objects. The computer software products may also be component software such as Java Beans (from Sun Microsystems) or Enterprise Java Beans (EJB from Sun Microsystems).

An operating system for the system may be one of the Microsoft Windows® family of operating systems (e.g., Windows 95, 98, Me, Windows NT, Windows 2000, Windows XP, Windows XP x64 Edition, Windows Vista, Windows CE, Windows Mobile), Linux, HP-UX, UNIX, Sun OS, Solaris, Mac OS X, Alpha OS, AIX, IRIX32, or IRIX64, or combinations of these. Other operating systems may be used. A computer in a distributed computing environment may use a different operating system from other computers.

Furthermore, the computer may be connected to a network and may interface to other computers using this network. For example, each computer in the network may perform part of the task of the many series of steps of the invention in parallel. Furthermore, the network may be an intranet, internet, or the Internet, among others. The network may be a wired network (e.g., using copper), telephone network, packet network, an optical network (e.g., using optical fiber), or a wireless network, or any combination of these. For example, data and other information may be passed between the computer and components (or steps) of a system of the invention using a wireless network using a protocol such as Wi-Fi (IEEE standards 802.11, 802.11a, 802.11b, 802.11e, 802.11g, 802.11i, and 802.11n, just to name a few examples). For example, signals from a computer may be transferred, at least in part, wirelessly to components or other computers.

In alternative implementations of the invention, the database may be a distributed database, where certain data is provided to particular devices or consoles. The database may be a relational, flat, or hierarchical database. The database may be stored in a single file or using multiple files. Some of the database files may reside on different machines, or all files may be on the same machine. For example, portions of the database may be stored on a portable or handheld device, such as a PDA.

In other implementations, the administration, monitoring, enforcement, and other tasks may be incorporated into a computer system in which the central server and database also reside. In other implementations, the information from the central server and database may be provided to distributed devices such as PDAs or electronic kiosks that perform designated functions.

In an implementation, sensor nodes, bridge nodes, display nodes, gateway nodes, and permit nodes form a wireless network. In one implementation, each parking space has a sensor node to detect the presence or absence of a vehicle in a parking space. In other implementations, a single sensor node may detect vehicles in more than one parking space or multiple sensor nodes may detect vehicles within a single parking space.

In one implementation, bridge nodes relay the information from the sensor and permit nodes to display and gateway nodes in real time. Bridge nodes actively participate in networking protocols to aggregate data from the sensor and permit nodes, compute information, and send results to display and gateway nodes. Bridge nodes are generally placed in locations to optimize communication with sensor nodes, permit nodes, display nodes, and gateway nodes. In another implementation, bridge nodes may not exist and the sensor and permit nodes may create a multi-hop mesh network among themselves to transmit messages to display and gateway nodes.

In one implementation, gateway nodes interface with the central server and the rest of the wireless network deployed to enable the monitoring of parking activities. The central server receives continuous data feeds from the network related to parking enforcement, guidance, payment, administration, network health and management, and stores them in the central database. The server supports an intuitive web browser based interface that can be used to monitor parking activity, manage, and administer parking operations from a centralized location. In another embodiment, monitoring, management, and administration of parking operations may be distributed across multiple servers.

Sensor nodes are installed in parking spaces to provide accurate vehicle presence measurements. In an embodiment, a parking management system uses magnetic sensors installed at parking spaces to detect vehicles. In other implementations, the sensor node may use other sensor technologies, such as ultrasonic, electromagnetic wave or impulse, laser, optical, infrared, acoustic, physical or mechanical switch, sound, temperature, pressure, or some combination of sensor technologies.

In a specific embodiment, the sensor is embedded on a battery-operated printed circuit board that also contains a microcontroller and a radio for wireless communication. This entire package may be referred to as a sensor node. In alternative embodiments, the board may be powered by line power. For example, the board may be primarily line powered and then the battery is for back-up purposes, in case there is a power failure.

In the case where the sensor node consumes relatively low power (which is generally desirable), batteries may power the sensor and accompanying circuitry for many years, without needing to replace the batteries. Batteries may last, for example, for five or ten years or more without replacement. Further, the sensor may be powered by power sources such as solar cells. The solar cells may be used to recharge a battery. A system of the invention may include sensor nodes that are powered differently from each other. Some sensor nodes may receive line power while other sensors receive battery power or solar power.

Instead of wireless communication, a sensor node may use a wired network for data communication. A system of the invention may include some sensor nodes which are wired and others that are wireless. Regardless of how the sensor node communicates its data, wirelessly or wired, its power source may vary (e.g., battery, solar, or line). Further, in some embodiments, the wire for data communications may also be used to power the sensor node (e.g., power over Ethernet).

In a specific implementation, the sensor board is housed in a robust, environmentally-sealed enclosure that is unaffected by weather and lighting conditions. However, the board may be housed in any enclosures as dictated by the environment in which the board and sensor will be subjected. For example, an outdoor-located sensor may be weatherproofed and made resistant to ultraviolet radiation. A sensor node to be located on the ground may be made especially durable because it might be run over by a sports utility vehicle (SUV).

The system of the invention is easy to deploy and cost-effective to maintain. The packaged sensor unit is easy to install, which enables low-cost, rapid deployment of the sensor nodes. Due to the sensor nodes' small size, they are aesthetically appealing and do not interfere with the commuters' parking activities. The sensor nodes also remain inconspicuous within the parking lot infrastructure, as to avoid attracting undue attention from visitors. Since the sensor nodes could run on batteries, the installation cost remains low since there is no need to run cables to power them or connect them to form a network.

In other implementations, the placement of the sensor nodes in the proximity of the parking spaces may vary based on the sensor node's capabilities as well as the layout of the parking spaces. For example, there could be multiple cameras monitoring the same parking space, or a single ultrasonic sensor responsible for each individual parking space.

In one implementation, a sensor node may have a short radio range as it uses a low power radio. In order to increase the effective wireless range of sensor and permit nodes, a bridge layer containing bridge nodes collects sensor and permit data and relays the data to the display and gateway nodes. The bridge nodes form the core wireless network with sensor and permit nodes at the edge of this core network. In another embodiment, sensor and permit nodes could communicate directly with display and gateway nodes using high bandwidth or long range links, such as IEEE 802.11 wireless links or WiMax radio links. In yet another embodiment, sensor and permit nodes may form a peer-to-peer mesh network among themselves and leverage multi-hop message communication to deliver messages to display and gateway nodes.

As soon as a sensor node detects the arrival of a new vehicle it informs a bridge node so that the occupancy status of the parking space may be updated in the system real-time. If the vehicle contains a permit node, then the permit node initiates a network discovery protocol, estimates its physical location, and transmits its location information along with the permit credentials to a bridge node. The bridge node forwards the credentials onto a central server which verifies if the vehicle has sufficient rights to park in the parking space.

All commuters that park at permit based parking spaces get the associated permit nodes installed on their vehicles which are automatically checked when they park. If the appropriate permit node is present on the vehicle it would respond with its credentials to prove that it is authorized to park in the given parking space. If a sensor node detects a vehicle but the system does not receive valid permit credentials from the vehicle, an alert is raised to notify a permit based parking violation.

A variety of wireless technologies, such as low power IEEE 802.15.4, Bluetooth, IEEE 802.11 radio links, or other technologies may be used for communication between the permit node in the vehicle and a bridge node deployed in the parking facilities. To help conserve battery power on the permit node, a commuter may have to turn on his permit node in his vehicle after parking so that it may communicate with the permit verifiers in the parking facility.

In one embodiment, in the case of a paid parking facility, the central server also communicates with a parking revenue management system to get information regarding the payment status of a parking space once it gets occupied. The central server may initiate a request to the parking management system to retrieve this information. Additionally, the parking revenue management system may also asynchronously send the central server the payment related information as soon as a payment is made.

The gateway node at one end of the parking lot interfaces the low power wireless network deployed at the parking lot to a central server. The server contains a central data repository that stores data related to parking enforcement, administration, network health and management. The server issues alert notifications to alert devices. Additionally, the server supports client machines from which users may define parking policies, monitor activities, as well as administer and manage the system.

Sensor nodes are devices that accommodate appropriate sensors to detect the presence or absence of a vehicle in a parking space.

Alert devices are electronic devices used to flash parking violation alert messages to parking enforcement personnel. These devices may be handheld devices such as PDAs, pagers, cell phones or vehicle dashboards. The alert messages could be text messages on PDAs, vehicle dashboards, or pagers. The alerts could also appear as short message service (SMS) or text messages on cell phones. Additionally, alert devices could also correspond to a browser in which the alerts are displayed. Moreover, any system consuming the alert via a software API could also correspond to an alert device.

Permit nodes are electronic devices installed on vehicles to store credentials that authorize parking in permit based parking spaces.

Bridge nodes form part of the underlying communication infrastructure and help transfer information in real time from sensor nodes to the gateway and vice versa. They generally reside in the heart of the network and actively participate in networking protocols.

Central server receives continuous data feeds from the network related to parking space occupancy, administration, network health and management. The server processes this information to issue any parking policy violation alerts and also stores information in a central database. Additionally, the server hosts software that supports an intuitive web browser based interface that can be used to monitor parking activity, as well as manage and administer parking operations.

Gateway nodes are the nodes that interface the Server with the rest of the wireless network deployed within a parking lot.

Display nodes are electronic variable message signs located at strategic positions (e.g., key intersections) to inform visitors about parking space availability as they navigate through the parking lots. The display is typically mounted above the ground and closer to the ceiling for easy visibility to visitors.

Administrative console consists of a comprehensive set of tools to setup, configure, and maintain the system. Its features include network installation and control, radio testing software, graphical node depiction, trace and debug tools, device status, performance and fault alarms, administrative alerts and enhanced security.

Monitoring console is an intuitive interface to graphically view real-time information on parking activities remotely. For example, there are views to show parking space occupancy and current or past parking violations on graphical parking lot maps. Network health and management collected from the wireless network is displayed at the monitoring console too. The monitoring console also displays parking policy violation alerts and reports on historical parking activity and operations.

Policy definition console helps with the definition of parking policies, the association of policies with parking spaces, and the association of violation alerts with the appropriate parking enforcement personnel.

Parking revenue management system includes capabilities to collect payments from visitors when they park within paid parking facilities. The system may include one or more payment nodes. Examples of payment nodes include parking meters, and pay-by-space machines. The parking revenue management system provides payment related information to the central server to help in the enforcement of paid parking policies.

Design of Parking Policy Definition

The policy definition console is used to define the parking policies in the system. In one embodiment, the policy definition console can be a client application that allows users to define different types of parking policies and it stores them directly in the central database. As described earlier, the different types of parking policies that can be defined include:

(1) Time of the day restrictions.

(2) Duration restrictions.

(3) Permit restrictions.

(4) Paid parking restrictions.

Each parking policy is uniquely identified in the system and can be applied to one or more parking spaces. Parking policies may be enforced only during certain working hours or at all times.

Each policy is associated with a working hour scheme that determines the times when the policy is active. Each working hour scheme includes one or more time segments that define the set of hours in a day, and a repetition frequency. A time segment consists of a contiguous interval of time. Examples of time segments include: “from 8 a.m. to 5 p.m.” and “from 2 a.m. to 6 a.m.” Each working hour scheme combines the intervals across its set of time segments to derive the working hours for the day. For example a working hour scheme may combine two time segments “from 9 a.m. to 11 a.m.” and “from 1 p.m. to 3 p.m.” to define the working hours to range from 9 a.m. to 11 a.m. and from 1 p.m. and 3 p.m.

Working hour schemes can also be associated with a repetition frequency. The repetition frequency defines a periodic time interval and the specific recurring day or days during the period when the policy will be active. Some examples of repetition frequencies include: week as the periodic time interval and each weekday as the days on which the policy is active; week as the periodic time interval and each weekend day as the days on which the policy is active; week as the periodic time interval and every Monday as the specific recurring day during the week when the policy will be active; year as the periodic interval and every December 24 (i.e., Christmas eve) as the specific recurring time during the year when the policy will be active; and month as the periodic interval and every second Wednesday as the specific recurring day during the month when the policy will be active.

Once defined, a policy can be applied to one or more parking spaces. Additionally, multiple policies can be applied to the same parking space. In the case of multiple policies being applied to a single space, the user can combine the policies into a composite policy using the Boolean logical operators AND, OR, and NOT.

For example, let policy A represent a permit parking policy which requires an employee permit and let policy B represent a restricted parking duration policy that allows a vehicle to park for only two hours. If both these policies are applied to a parking space, they could be combined to create a new policy as follows: (A OR ((NOT A) AND B)). This new policy allows a vehicle to be parked in the space if it has an employee permit. If not, the vehicle can park in the space for a maximum of two hours.

Parking administrators could also define a grace time period after which a policy should be enforced. For example, if a two-hour restricted duration parking policy has a grace period of ten minutes, an alert is raised only if the vehicle is parked in the space for more than two hours and ten minutes.

Parking administrators could also define whether a policy can be repeatedly and consecutively enforced on a violating vehicle. For example, if a 30 minute restricted duration policy is repeatedly enforced, then two parking violation alerts are raised if the vehicle is parked in the space for sixty five minutes.

If a parking policy is violated, an alert is sent to an alert device. The parking administrator can specify which parking enforcement officers or officers should receive a parking violation alert at a given parking space at a given time. In general, an alert may be issued to one or more parking enforcement officers based on a variety of factors including, but not limited, to the following: geographic location or zone of parking space where the violation occurred, type of violation, time of violation, workload on enforcement officer, location of enforcement officer, past history of alerts issued to the enforcement officer, performance of the enforcement officer, and other factors.

The central server loads the parking policies and their associations with different parking spaces upon startup and analyzes the parking activity to detect any violations.

There are a number of ways in which a parking administrator can set up the notification of the violation alerts. For example, if the parking zones are divided into areas that are reasonably sized as to be controlled by a single parking enforcement officer, then that enforcement officer would receive an alert for a violation in the officer's assigned area.

In another implementation, a number of parking enforcement officers may be assigned to partially or completely overlapping parking zones. The advantage of the latter implementation is that if one enforcement officer is busy, other enforcement officers may respond and act on the alert. In alternative deployments, the system is aware of the real-time location of the parking enforcement officers and could send the alert to the enforcement officer who is closest to the violated parking space. In an alternate implementation, the system could track the enforcement officer's activities and send the alert to an enforcement officer that is available at that moment and not busy handling prior alerts or other activities.

Design of Vehicle Detection and Parking Space Monitoring

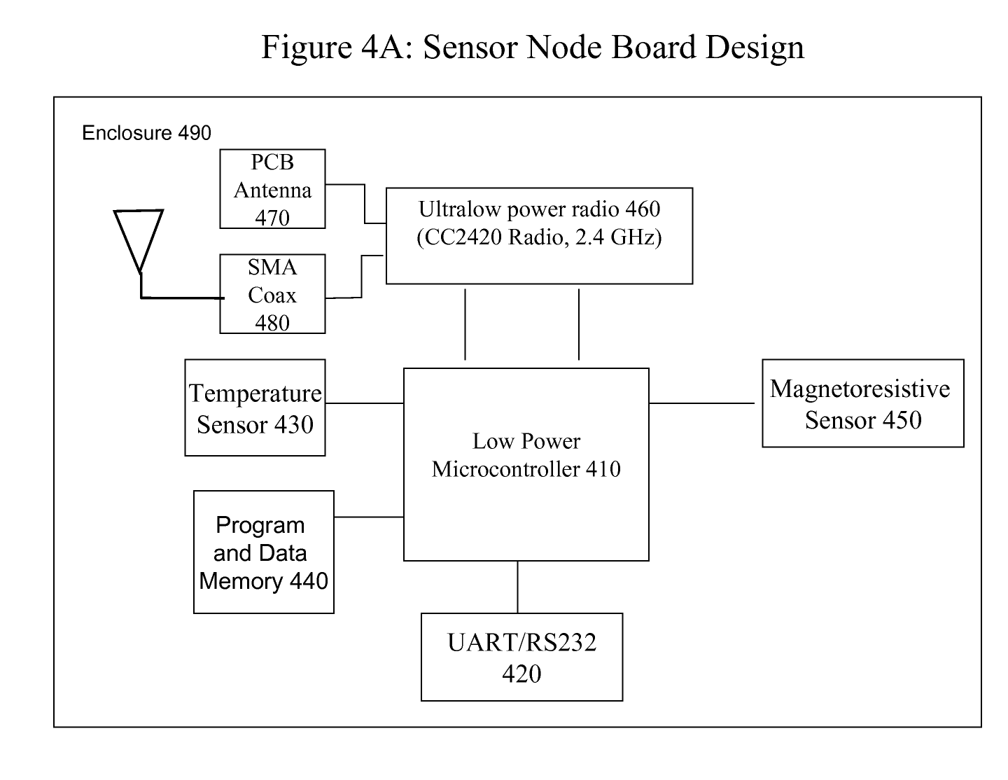

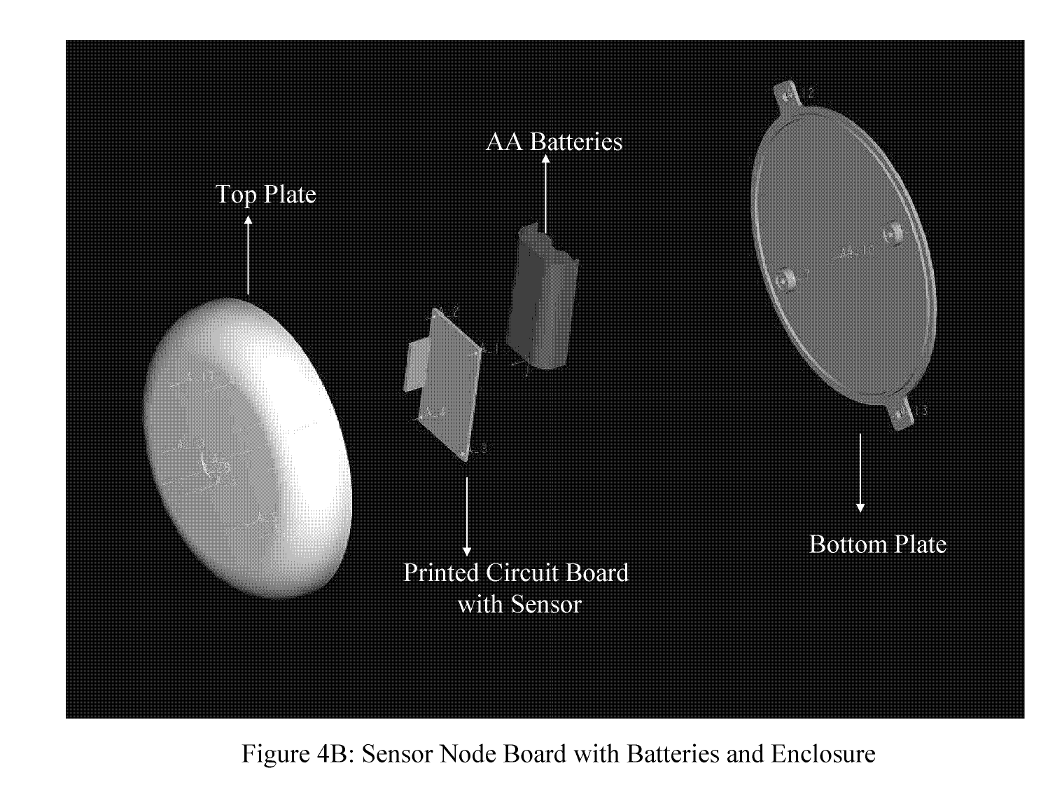

FIG. 4A shows a functional schematic diagram of a board design of a sensor node. The key elements of the sensor node hardware include a board with the following components:

(1) A microcontroller 410 such as Texas Instrument's MSP430 or LPC 935 from Philips Semiconductor, connected to a Universal Asynchronous Receiver-Transmitter (UART) using the RS232 standard 420, a temperature sensor 430, and program and data memory 440.

(2) A magneto-resistive (MR) sensor 450, such as Honeywell's HMC 1022 or HMC 1043.

(3) A radio frequency (RF) transceiver 460 such as Chipcon 2420, connected to a printed circuit board (PCB) Antenna 470 and SubMiniature version A (SMA) RF connector 480.

(4) A battery pack.

(5) An enclosure 490.

FIG. 4B shows the sensor node hardware. The printed circuit board with a sensor and a battery pack is encased in an enclosure with a top plate and a bottom plate. The sensor node enclosure is robust, environmentally-sealed, and protects the sensor board from weather, water, oil, humidity, and lighting conditions. The board may be housed in any enclosure as dictated by the environment to which the board and sensor will be subjected. For example, an outdoor-located sensor may be weatherproofed and made resistant to ultraviolet radiation.

A sensor to be located on the ground may be made especially durable because it might be run over by a large sports utility vehicle (SUV). Such an enclosure may be made of a nonmagnetic durable material such as the Lexan polycarbonate compounds manufactured by GE Plastics. The enclosure material may not interfere with the sensor node's wireless communication. Moreover, the enclosure may be openable to allow for the replacement of batteries.

The sensor node hardware design is designed to operate on very low power. Since the nodes run on batteries, they are designed with some key features to maximize battery life.

The microcontroller supports “sleep” mode, allowing for minimum power consumption when the node is in an inactive state for a certain amount of time. During “sleep” mode the microcontroller is inactive and consumes very little power (only a few microamps).

The embedded software controls the mode of the microcontroller and decides when the microcontroller should be active and when it should be in “sleep” mode. Moreover, the software determines when the RF transceiver should be turned on and when it should be switched off. The RF transceiver is switched on only when the sensor node needs to communicate and is switched off otherwise.

Additionally, the embedded software determines when the magnetic sensor is turned on and when it is switched off. The magnetic sensor is turned on only when the sensor node is required to measure its local magnetic field. The sensor node is based on a modular hardware design that allows for power consumption to be optimized by only powering the elements selectively. The sensor circuit is active or powered only when required for sampling sensors and communicating messages.

Software on board can obtain digital values of the sensor output.

In one embodiment, the RF transceiver supports an RF range up to 100 feet. In other embodiments, the RF range may be greater than 100 feet. In other embodiments, a power amplifier may be used to increase the transmission range of the sensor node.

In one embodiment, the RF transceiver operates in the frequency band of 2.4 gigahertz. In other embodiments, the RF transceiver may operate at frequencies lower or higher than 2.4 gigahertz.

In one embodiment, the sensor circuit is active or powered only when required for sampling sensors and communicating messages.

In one embodiment, a two-axis magnetometer may be used to detect the presence of a vehicle in a single parking space. During installation of the sensor node, the placement of the node is such that one axis (e.g., X axis) of the sensor is parallel to the length of the vehicle and the other axis (e.g., Z axis) measures the vertical magnetic field.

In one embodiment, high capacity, small form factor batteries power the node. In other embodiments, other types of batteries or other methods may be used to power the node.

Since the reliability of the sensors readings is affected by environmental conditions such as temperature. The embedded software offsets the observed reading by the expected error margin to obtain a more accurate value of the sensed parameters. The circuit includes a temperature sensor to compute the offset in readings caused by external climate conditions.

In one specific implementation of the invention, activities such as sensing, communication, data processing, and listening to the wireless medium for messages have been optimized to reduce power consumption. At the sensor node level, battery life is optimized through minimization of the number of transmissions and periodically switching off the radio. A data packet for transmission to the bridge layer is generated only when the sensor readings are processed and confirm a change in the occupancy state of a parking space. For example, a data packet is generated only when the occupancy status of a parking space changes from occupied to empty or from empty to occupied. The radio at the sensor node is turned off when it does not need to communicate.

In one implementation of the invention, the execution environment at the sensor nodes is assembly language. In another implementation, the execution environment may be a higher level programming language. The microcontroller at the sensor node has few software registers to store the necessary configuration parameters and enough memory to store and execute the code and sensor readings.

Software Design of Sensor Nodes

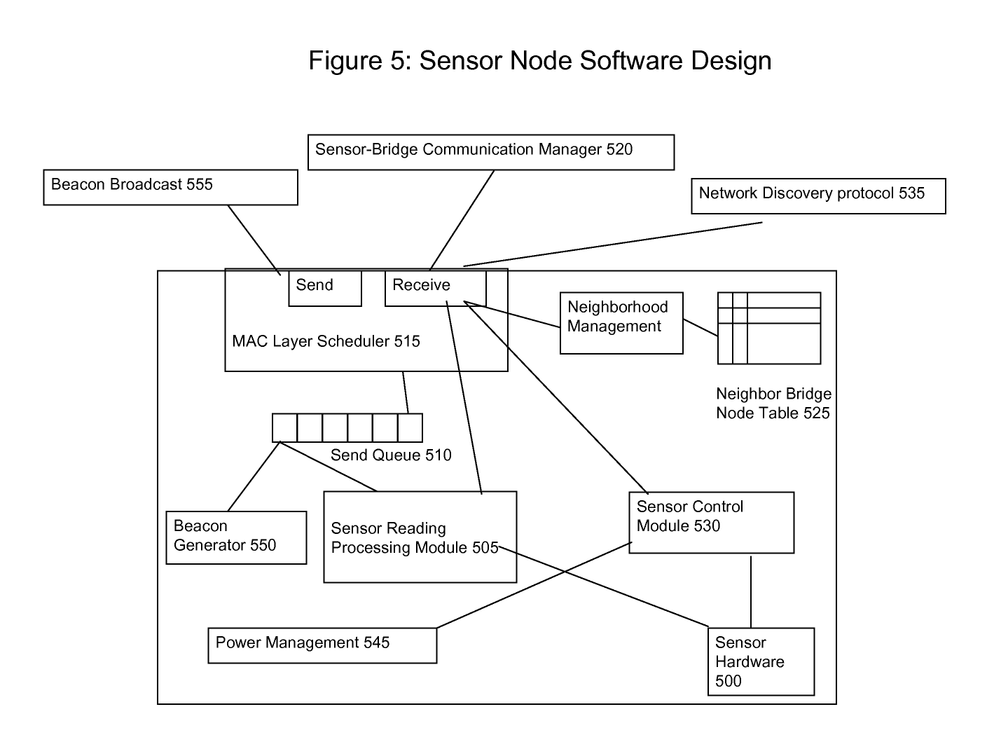

FIG. 5 shows a block diagram depicting the interaction of software modules at the sensor node. The interacting components include the sensor hardware 500, a Sensor Reading and Processing module 505, a send queue 510, a MAC Layer scheduling 515, a Sensor to Bridge communication manager 520, a neighbor bridge node table 525, and a sensor control module 530. When there is an event to report, the sensor sends data to the reading and processing module. The reading and processing module relays the data to the send queue. The MAC scheduling module schedules transmission of the data packet to the Sensor-Bridge Communication Manager. The MAC layer also schedules beacon broadcast messages 555 from the beacon generator 550.

After installation, the sensor nodes are calibrated to use the earth's magnetic field as a baseline to identify with a no-vehicle scenario. These calibrated readings are automatically adjusted to the midpoint of the scale to help measure the widest possible deviations above and below the baseline readings. The sensor nodes run a network discovery protocol to populate the neighbor bridge node table with neighboring bridge nodes. The sensor-bridge communication manager at the bridge node also synchronizes the time between the sensor node and the bridge node. Power management 545 conserves energy at the sensor control module and the MAC layer.

In other implementations of the invention, two or more modules and protocols may be combined into a single module or protocol, or a single module or protocol may be divided into multiple modules and protocols. Additionally, the sensor control module may be incorporated into the sensor hardware.

In an implementation, sensors periodically detect the presence or the absence of a vehicle in a parking space. This sensing interval can be configured to improve overall accuracy of parking space occupancy information. In one configuration, the sensing interval can be set to one second. At the end of the sensing interval, the sensor readings are processed by the sensor reading and processing module to determine if the occupancy status of the parking space has changed. If there is no change in the occupancy status, no event is generated. If there is a change, a valid event is generated and then buffered at the send queue for transmission to the bridge node.

In an implementation, sensor nodes discover bridge nodes in their neighborhood shortly after network installation, and store them in a local database, or the neighbor bridge node table. They select the node with best link quality as the parent bridge node. If there is an event to report at the end of a sensing interval, sensor nodes schedule transmission to their parent bridge nodes during a time interval called M2B frame in the MAC layer. The MAC layer will be explained in a later section. The MAC layer is implemented at both sensor nodes and bridge nodes. The MAC layer schedules time periods for sensor node to bridge node as well as bridge node to bridge node communication.

The event transmission from the sensor node is sent to the sensor-bridge communication manager in the parent bridge node. After event transmission, the sensor node waits for an acknowledgement packet (ack) from the bridge node. If the sensor node fails to receive an acknowledgement packet within an acknowledgement packet timeout interval, the sensor node will retransmit the event packet. Time synchronization occurs at the sensor node to ensure reliable scheduling of the M2B frames. The parent bridge node is responsible for sending time synchronization messages to the child sensor node to make sure the sensor node's local time does not drift away from the bridge's local time.

The sensor node also controls configuration of the sensor hardware through the sensor control module. The sensor control module could control configuration settings such as sensor calibration, software thresholds for sensor readings to detect occupancy of a space, and control parameters such as the sensing interval. These configuration and control parameters are set by the sensor control module. The sensor control module is also responsible for sending periodic health parameters, such as residual battery power and sensor hardware malfunction information to the parent bridge nodes. The bridge nodes further route this data as part of the network health and management data to the central server that can make the data available to the administrative console.

In one implementation, the system may support network programming to transmit program code wirelessly from a bridge node to a sensor node. The program code is loaded into the sensor node from the bridge node, and the sensor node executes the new code. Network programming saves the efforts of uninstalling and reprogramming each sensor node manually.

In one embodiment, the sensor node is configured with its physical coordinates and includes a software module called a beacon generator. The beacon generator generates beacon events that need to be broadcasted and they contain a time stamp and the physical coordinates of the sensor node. The MAC scheduler schedules the transmission of these beacon events during a predefined time slot during a time interval called the beacon frame in the MAC layer.

Parking Space Occupancy Monitoring

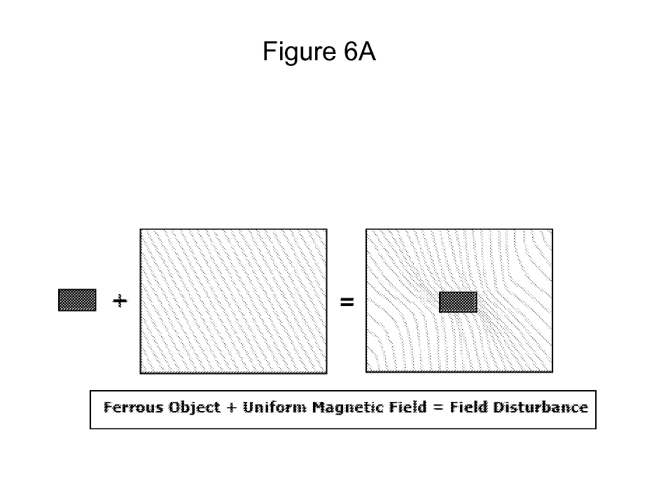

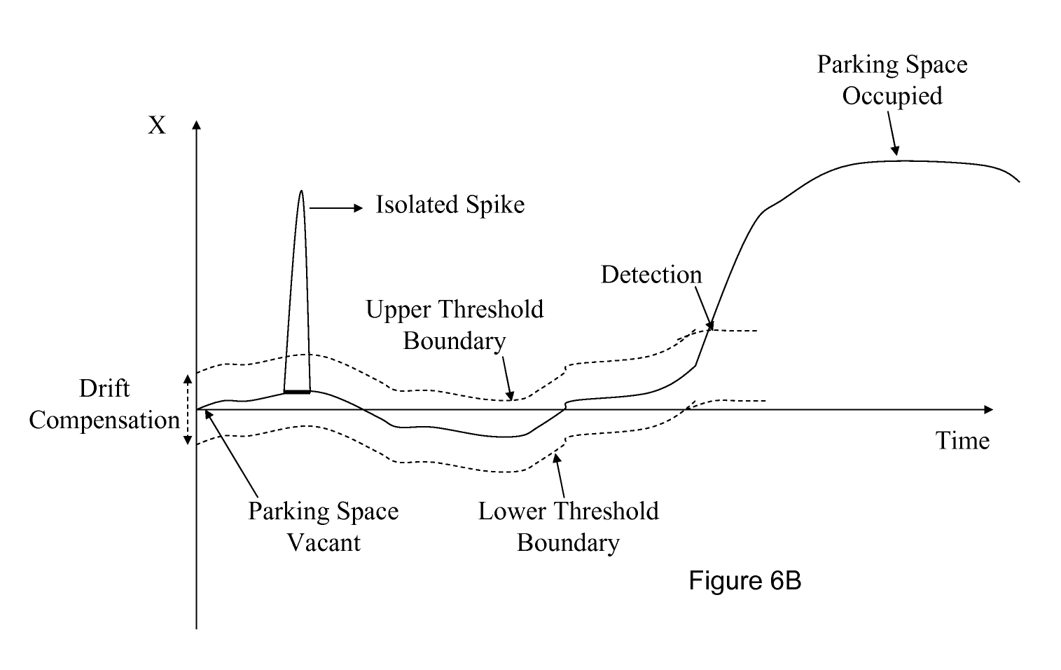

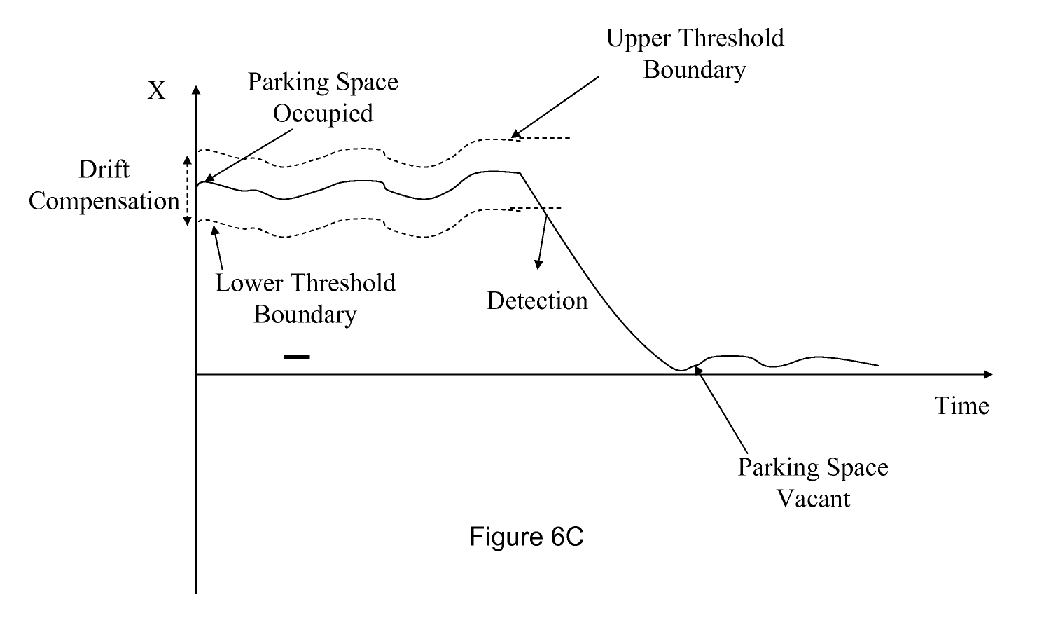

FIG. 6A shows a ferrous object causing a disturbance in a uniform magnetic field. When a vehicle occupies a parking space, it creates a local disturbance to the earth's magnetic field around the parking space. A magnetic sensor can sense this disturbance by processing the changes in the readings along each magnetic axis and detect that the parking space is occupied. The magnetic sensor uses the earth's magnetic field as a baseline to identify with a no-vehicle scenario. As a vehicle parks in the proximity of the sensor, the sensor detects a sudden non-transient shift in its local magnetic field away from its baseline (no-vehicle) value.

FIGS. 6B and 6C show how a sensor node compensates for drifts in its magnetic readings. To accurately sense stationary vehicles, the sensor nodes must compensate for the changes in the magnetic readings due to drift. The drift in the readings can arise from small changes in the magnetic field that occur on an ongoing basis. Drifts can also arise from temperature changes that impact the sensor's readings. Not compensating for drift can lead to erroneous readings on whether a vehicle is present.

In one embodiment, a software algorithm can detect small, slow changes in the magnetic readings and reject them. The algorithm could measure the earth's field bias value and set upper and lower thresholds based on a fixed amount for a desired detection range. As shown in FIG. 6B, the upper and lower thresholds are continuously set to compensate for thermal drifts and magnetic field drifts. As a vehicle approaches the sensor, magnetic readings change faster than the drift compensation algorithm is allowed to shift, thus resulting in a valid vehicle detection.

After the vehicle has finished parking in the space, new upper and lower drift compensation thresholds are continuously set as shown in FIG. 6C. When a vehicle leaves, the magnetic readings change faster than the drift compensation algorithm is allowed to shift, thus resulting in a valid vacant parking space detection. After a vehicle leaves, the magnetic sensor is pulsed with high currents to enable it to clear any remnant flux and to help it perform accurate measurements of its local magnetic field.

The software algorithm also compensates for sudden, transient, short-lived changes in magnetic readings that correspond to isolated spikes. An isolated spike may be characterized as a rapid rise and fall (or fall and rise) in magnetic readings within a very short period of time (e.g., less than a second).

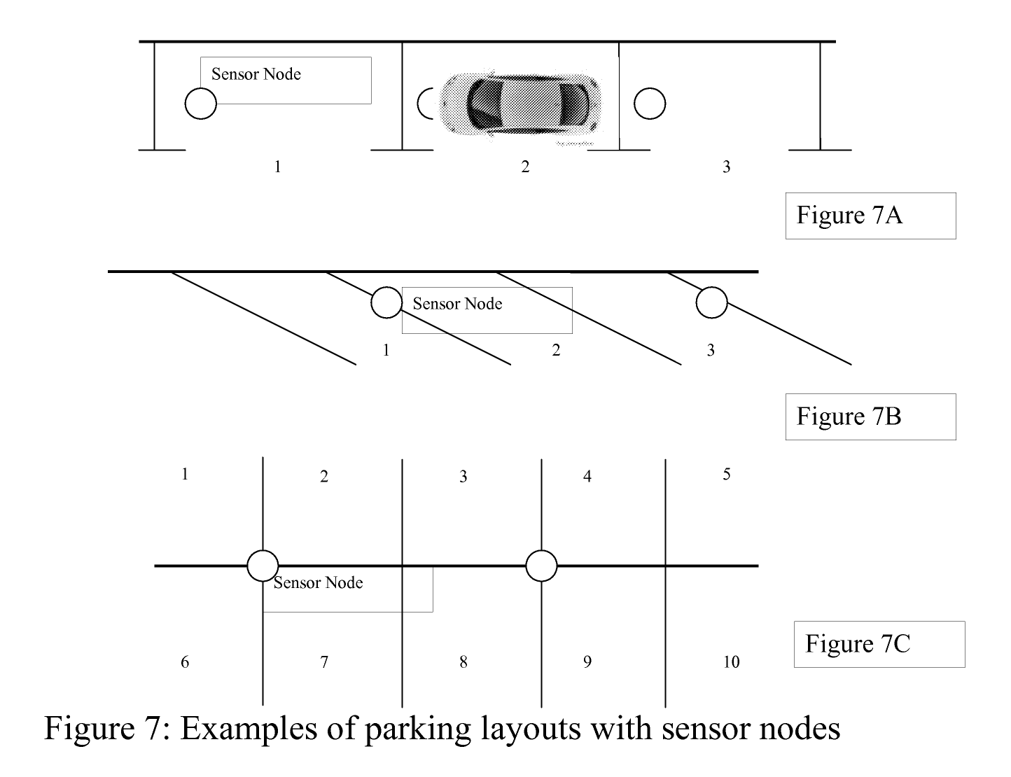

FIGS. 7A, 7B, and 7C show three examples of parking layouts with magnetic sensors to detect space occupancy. In other implementations, other types of sensor technologies, such as ultrasonic, cameras, electromagnetic wave or impulse, laser, optical, infrared, acoustic, physical or mechanical switch, or pressure may be used. A single sensor node may detect the occupancy status of one or more parking spaces. In FIG. 7A, a single sensor tracks the occupancy status of one parking space. In FIG. 7B, one sensor tracks the occupancy status of two parking spaces. In FIG. 7C, a single sensor tracks the occupancy status of four parking spaces.

The sensor is calibrated to record the earth's local magnetic field. Then, if a vehicle occupies a particular parking space, the sensor detects the magnitude and direction of the change in its local magnetic field to identify which one of the parking spaces it is monitoring is occupied. The sensor node periodically samples its local magnetic field at high frequency and continuously tracks the occupancy status of its parking spaces. As vehicles enter and exit the spaces, the sensor records the magnitude and direction of the change in its local magnetic field to identify which one of the parking spaces it is monitoring underwent a change in occupancy status.

In other implementations, sensor nodes may collaborate with each other to enhance the accuracy of data sensed by individual sensors. Sensor readings related to parking space occupancy may be exchanged among multiple nodes in the proximity of that space. Such local collaboration can provide more accurate results compared to independent inferences drawn based on individual sensor's readings.

An implementation may use one of the above methods to track the occupancy status of the parking facility or it may employ any combination of methods. Additionally, different sensor technologies may be used in addition to the methods described above to monitor the occupancy status of the parking facility. For example, in one implementation camera based sensors may be used in addition to magnetic sensors to monitor parking space occupancy.

Hardware Design of Permit Nodes

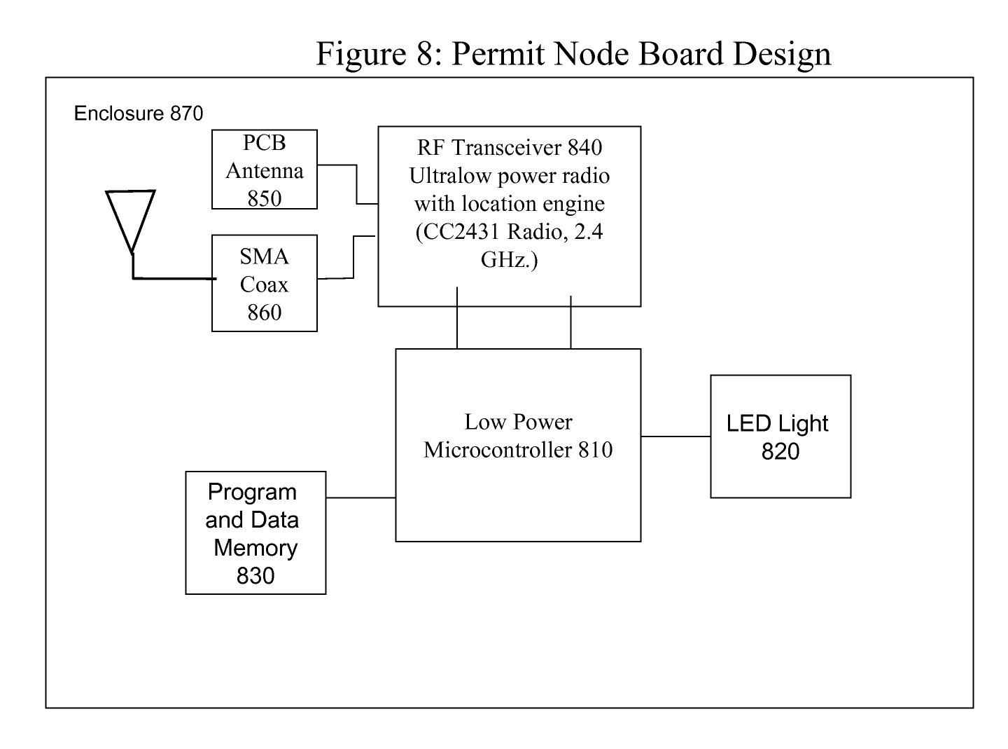

FIG. 8 shows a functional schematic diagram of a permit node. The key elements of the permit node hardware include a board with the following components: (1) microcontroller 810, such as Texas Instrument's MSP430 or LPC 935 from Philips Semiconductor, connected to a light emitting diode (LED) light 820, and program and data memory 830; (2) RF transceiver 840 with location engine such as Chipcon 2431, connected to a PCB Antenna 850, and SMA Coax 860; (3) battery pack; and (4) enclosure 870.

In one implementation, since the permit node hardware is designed to operate on batteries, they consume very little power. Since the nodes run on batteries, they are designed with some key features to maximize battery life.

The microcontroller supports “sleep” mode, allowing for minimum power consumption when the node is in an inactive state for a certain amount of time. During “sleep” mode the microcontroller is inactive and consumes very little power (only a few microamps).

In one embodiment, the permit node is required to be switched on after a car has been parked in a permit based parking space. When the permit node is switched on, an LED light in the permit node comes on to display its active status. The LED light is turned off when the node is switched off.

In one embodiment, the RF transceiver supports an RF range up to 100 feet. In other embodiments, the RF range may be greater than 100 feet. In other embodiments, a power amplifier may be used to increase the transmission range of the permit node.

In one embodiment, the RF transceiver operates in the frequency band of 2.4 gigahertz. In other embodiments, the RF transceiver may operate at frequencies lower or higher than 2.4 gigahertz.

In one embodiment, high capacity, small form factor batteries power the node. In other embodiments, other types of batteries or other methods may be used to power the node.

In one embodiment, to minimize the number of transmissions, the permit node transmits its credentials only when requested by a permit verifier.

In one implementation of the invention, the execution environment at the permit nodes is assembly language. In another implementation, the execution environment may be a higher level programming language, such as C, C++, or Java. The microcontroller at the permit node has few software registers to store the necessary configuration parameters and enough memory to store and execute the code.

Permit Node Software Design

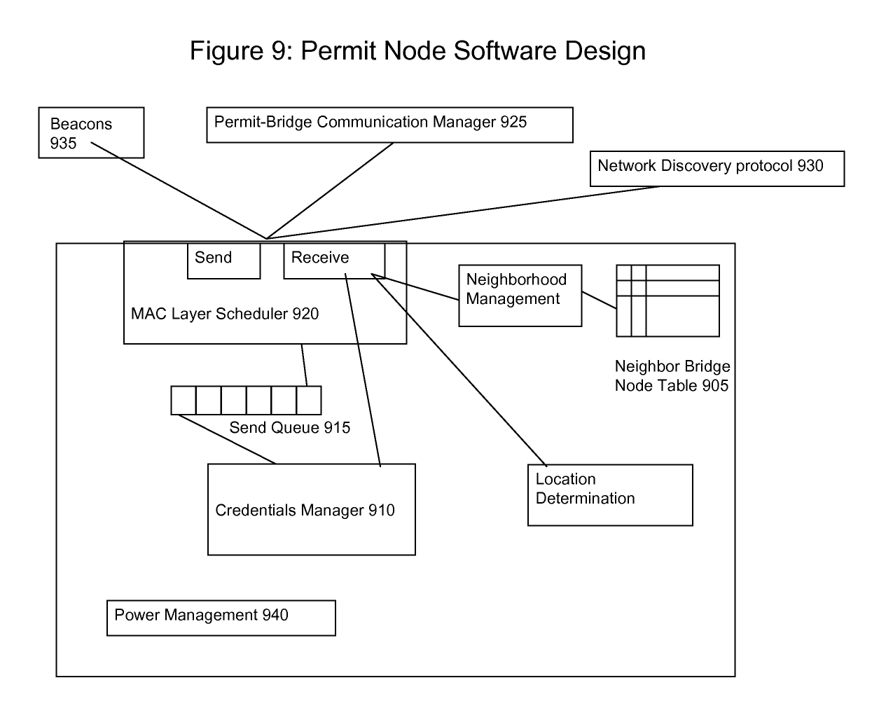

FIG. 9 shows a block diagram depicting the interaction of software modules at the permit node. The interacting components include the neighbor bridge node table 905, a credentials manager 910, a send queue 915, a MAC Layer scheduling 920, and a permit to bridge communication manager 925.

After being switched on, permit nodes run a network discovery protocol 930 to populate the neighbor bridge node table 905 with neighboring bridge nodes. The permit-bridge communication manager 925 at the bridge node synchronizes the time between the permit node and the bridge node. Additionally, the bridge node sends the permit node a location-based beacons 935 to inform the permit node of the physical coordinates of the bridge node and the permit node records the received signal strength (RSS) of the messages from the bridge node. The credentials manager 910 relays the data to the send queue 915. The MAC layer scheduler 920 schedules transmission of the data packet to the permit-bridge communication manager 925. The power management component 940 conserves energy at the permit node and the MAC layer.

After the permit node has received beacon messages from at least three different modules it uses the information from the beacons to estimate its own physical coordinates. In particular, in one embodiment, the permit node uses the radio based location estimation scheme such as the one described in David Taubenheim, Spyros Kyperountas, and Neiyer Correal, Distributed Radiolocation Hardware Core for IEEE 802.15.4, Motorola Labs, Plantation, Fla. to estimate its physical coordinates.

In an implementation, permit nodes discover bridge nodes in their neighborhood shortly, and store them in the neighbor bridge node table. They select the node with best link quality as the parent bridge node. The credentials manager generates an event to send the credentials of the permit node as well as its estimated location to the parent bridge node. This event includes the permit node identifier, the permit credentials, the permit expiration date, the permit node's estimated location, and the vehicle identifier (optional). The MAC scheduler in the permit node then schedules the transmission of the event to the parent bridge node in a time interval called the M2B frame in the MAC layer. The MAC layer is implemented at both permit nodes and bridge nodes and one of its tasks is to schedule time periods for permit node to bridge node communication.

The event transmission from the permit node is sent to the permit-bridge communication manager in the parent bridge node. After event transmission, the permit node waits for an acknowledgement packet (ack) from the bridge node. If the permit node fails to receive an acknowledgement packet within an acknowledgement packet timeout interval, the permit node will retransmit the event packet. Time synchronization occurs at the permit node to ensure reliable scheduling of the M2B frames. The parent bridge node is responsible for sending time synchronization messages to the child permit node to make sure the permit node's local time does not drift away from the bridge's local time.

In one specific implementation of the invention, activities such as communication, data processing, and listening to the wireless medium for messages have been optimized to reduce power consumption. At the permit node level, battery life is optimized through minimization of the number of transmissions and periodically switching off of the radio.

In one implementation, a permit node is required to be switched on to begin functioning. In one embodiment, the permit node can continue to listen for location-based beacon messages from other nodes. A location based beacon message is transmitted periodically by a node and it contains a time stamp and the actual physical coordinates of the node. The permit node records the received signal strength (RSS) of the message as well as the physical coordinates of the node.

In other implementations of the invention, two or more modules and protocols may be combined into a single module or protocol, or a single module or protocol may be divided into multiple modules and protocols.

Hardware Design of Bridge Nodes

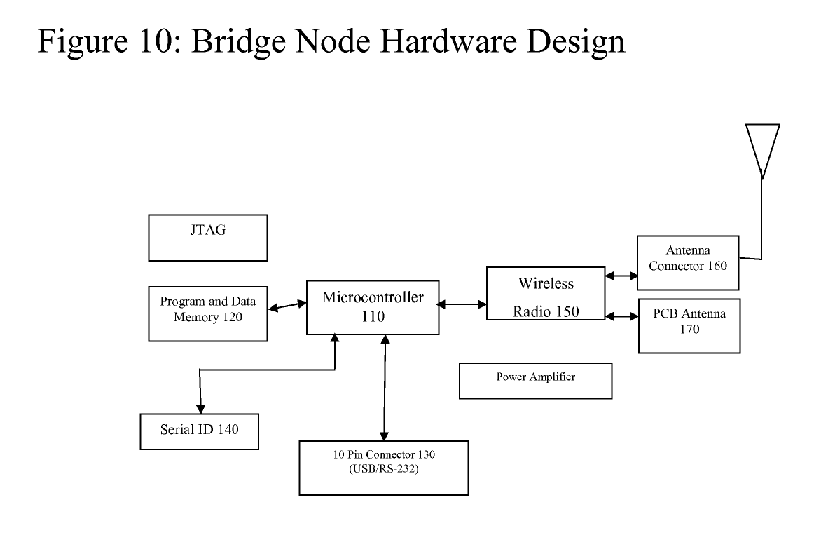

FIG. 10 shows a functional block diagram of a bridge node in a specific embodiment. Bridge nodes are equipped with a microcontroller 110 containing a serial identification (ID) 140. The microcontroller is connected to a ten-pin connector 130 and program and data memory 120. The microcontroller is also connected to a wireless radio 150 coupled with an antenna connector 160 and a PCB antenna 170. These devices or nodes may be line powered, battery powered, or powered through renewable sources of energy such as solar cells.

Bridge nodes form an underlying backbone network that connects sensor nodes and permit nodes to gateway nodes. In an implementation, bridge node radios form a short-range communication network with an average radio range of 50 meters to 100 meters. The range of the bridge node radio has an impact on where bridge nodes are located and how close bridge nodes will be next to each other. The range of a bridge node may vary. For example, the range may be greater than 100 meters. The range of a bridge node may be less than 50 meters. A spatially well-connected network of nodes allows each node to be surrounded by multiple neighbors in their radio range.

Typically, bridge nodes have an available bandwidth of about 250 kilobytes per second. However, in other implementations, the bandwidth may be less than 250 kilobytes per second, or the bandwidth may be greater than 250 kilobytes per second. The greater the bandwidth, the larger the rate at which data can be sent through the network.

The microcontroller can support the processing and memory requirements of the various application level tasks and networking software. The bridge nodes can also communicate with a wireless-enabled PDA or laptop computer running appropriate software. The bridge nodes are also equipped with flash memory so that in case of node failure it does not lose its configuration parameters and can reconnect with the network upon restarting.

In one implementation, the low power radios of the bridge nodes are omnidirectional and the presence of transient obstacles, such as rain and snow, and permanent physical obstacles, such as buildings, in the environment may affect their effective transmission range. To improve their transmission range in such cases, the nodes may use power amplifiers. The nodes are equipped with software link estimators to measure the quality of its radio link connection with neighboring bridge, permit, or sensor nodes. The link estimators are useful in determining the right separation between bridge nodes to maximize spatial reuse of the radio range, and to form a well connected wireless network after taking into account the loss of transmission range due to transient and permanent obstacles.

The Execution Environment

One implementation includes an embedded execution environment at the bridge node. An example of such an environment is TinyOS. TinyOS at the bridge nodes controls the different hardware components and provides the software platform to implement the data processing and networking software. TinyOS features a component-based architecture, which enables rapid innovation and implementation while minimizing code size as required by the memory constraints inherent in sensor networks. TinyOS's event-driven execution model enables fine grained power management while allowing the scheduling flexibility made necessary by the unpredictable nature of wireless communication and physical world interfaces. TinyOS already provides interfaces to various built-in devices such as radio power management and timer support. Other implementations may use an execution environment other than TinyOS such as Contiki (see A. Dunkels, B. Gronvall, and T. Voigt. Contiki, “A Lightweight and Flexible Operating System for Tiny Networked Sensors,” Proceedings of the First IEEE Workshop on Embedded Networked Sensors, November 2004, Tampa, Fla.) at the bridge node.

The gateway node uses the Linux operating system as the execution platform. The gateway node has storage to accept continuous data streams from the wireless network and buffer them in case its link to the central server experiences transient failures.

Design of Communication Layer

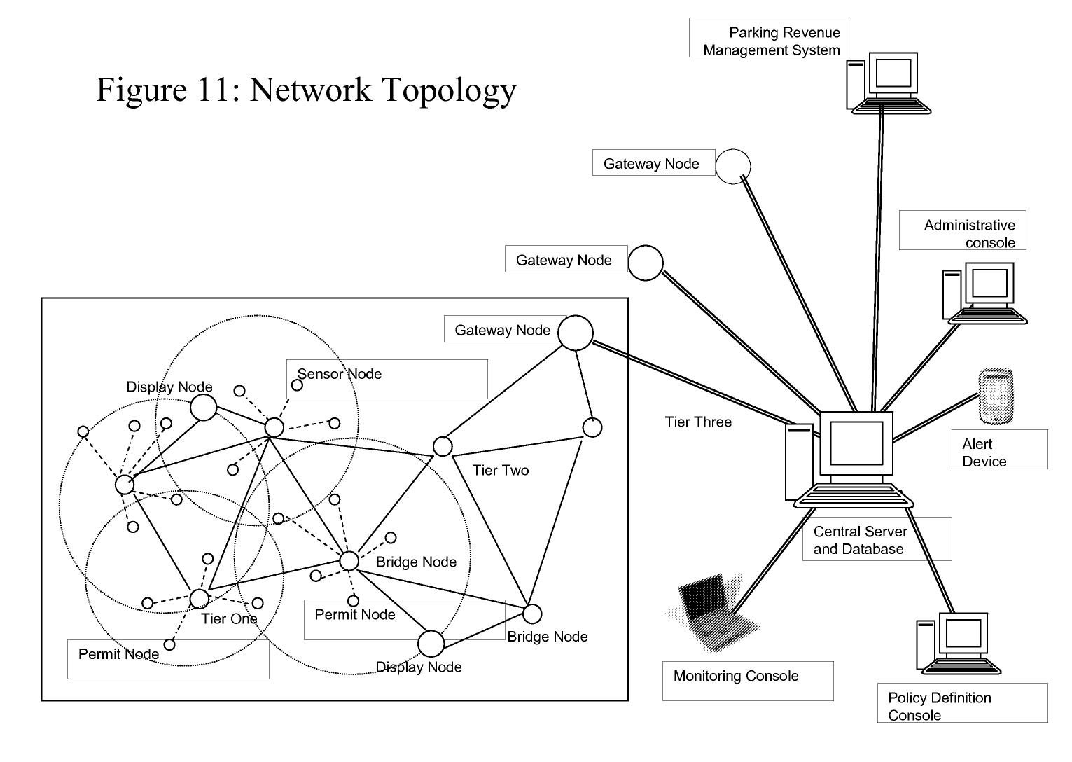

FIG. 11 shows a hierarchical organization of the network topology in one implementation. In an implementation, there are three main communication tiers. The bottom tier, or tier one, is represented by the dotted lines, is the low power, single-hop communication between the sensor nodes, permit nodes, and bridge nodes providing sensor data to the network.

The second communication tier is represented by solid lines. The second tier is the low power, ad hoc multihop network among the bridge nodes to route data to destination display nodes and gateway nodes.

The double lines in FIG. 11 represent the third communication tier. The third tier includes a wide area network link between the gateway nodes and the central server. Additionally, the third tier includes other links between the central server and its clients including the monitoring console and the administrative console. The links between the central server and its clients may be spread over a local or wide area network. In an implementation of the invention, the nodes and the clients may be geographically close to each other or separated by large distances. For example, the monitoring consoles may be spread over offices within buildings or may be mobile in the form of PDAs carried by traffic control personnel. Technologies such as General Packet Radio Service (GPRS), Worldwide Interoperability for Microwave Access (WiMAX), Ethernet, or Institute of Electrical and Electronics Engineers 802.11 (IEEE 802.11), or other wireless technologies may also be used to form the third communication tier of the wireless network.

In another implementation, the topology may be different. There may be less than three communication tiers, such as one or two, or there may be more than three communication tiers, such as four, five, six, seven, eight, nine, or ten or more.

In an implementation, sensor nodes at the bottom tier of the communication architecture are deployed in a dense manner such that the parking spaces being monitored are within their sensing range. The bridge layer network is sparse such that each bridge node is responsible for collecting data from a large number of sensor nodes in its radio range. Sensor nodes, also known as a “child sensor node,” typically report to bridge nodes, also known as a “parent bridge node,” that are geographically closest or have the best link quality over time. This ensures an even distribution of sensor nodes among the available bridge nodes. The “child/parent” relationship is dynamic during lifetime of the network. Sensor nodes select bridge nodes with the best bidirectional radio links at the current time as their parent bridge nodes.

In one implementation, manual placement of bridge nodes in the parking structure layout ensures that each bridge node has uniform spatial connectivity with its neighboring bridge nodes and is responsible for a large number of sensor nodes. Besides careful bridge node placement, validation by real deployment is important to account for loss in radio range due to physical obstructions such as buildings, metal bodies, mutipath fading, and poor connectivity.

In an implementation, the software complexity of the in-network computation and communication resides at the bridge nodes. Setting up the wireless network involves two phases.

The first phase is the bootstrap phase.

The bootstrap phase consists of network discovery to form a connected network and initialize the associated data structures. Below is pseudocode for the network discovery algorithm:

(i) On being turned on or reset, a node A sends a broadcast message with its location information and node ID.

(ii) A neighboring node B hears the broadcast message.

(iii) If Node B finds that the node A is not present in its neighbor table, then it sends a network discovery message to it with its location information.

(iv) Node A, on receiving the network discovery message, adds node B to its neighbor table along with its location information.

(v) Node A sends an acknowledgement message to node B which contains Node A's location information.

(vi) On receiving the acknowledgement message, node B adds node A to its neighbor table along with its location information.

(vii) Network discovery is a continuous process and the neighbor table maintains the data on the health of the links to each neighbor.

During network discovery, bridge nodes broadcast their identity in their neighborhood and receive identity broadcasts from their neighbors to initialize their neighbor tables. After a few iterations of exchanging network discovery broadcasts, bridge nodes form a well-connected network.

During network discovery, the sensor nodes also broadcast their identity to hear back from neighboring bridge nodes. The sensor nodes maintain a list of candidate parent bridge nodes in their radio range and select the one with best symmetric link quality to be their current parent bridge node.

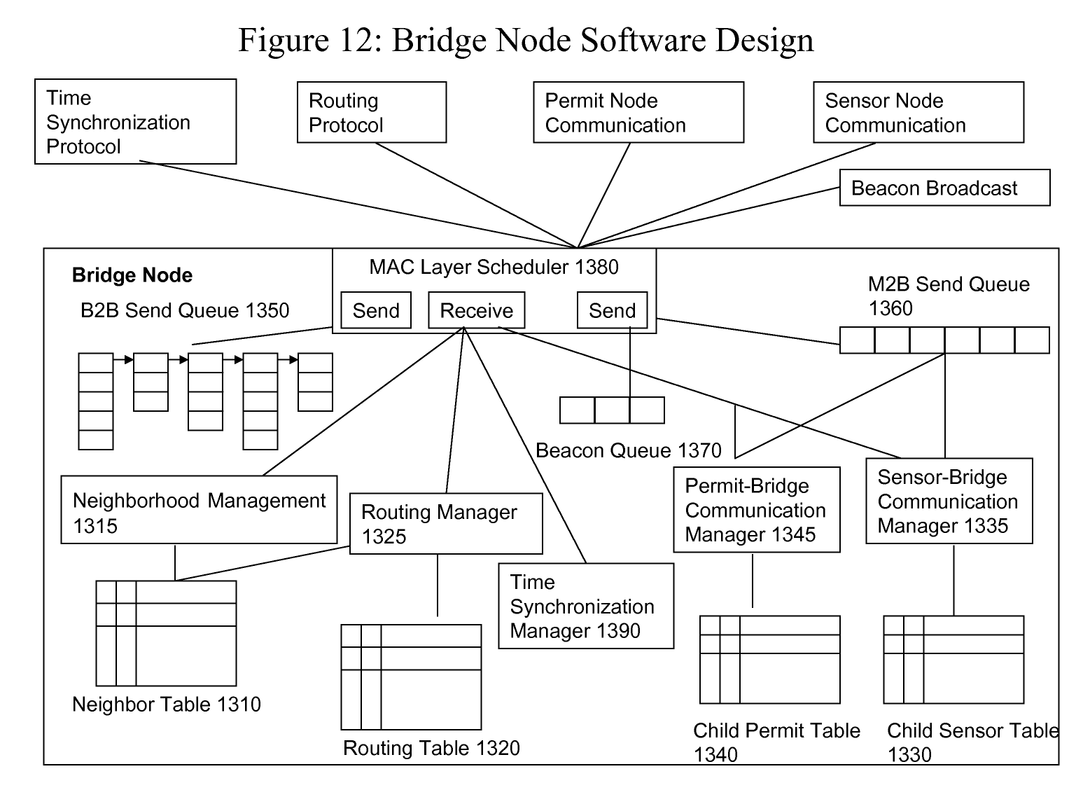

FIG. 12 shows the interaction among the key modules at a bridge node. The key data structures at the bridge node level include: (1) a neighbor table 1310 (2) a routing table 1320, (3) a child sensor node table 1330, (4) a child permit table 1340, (5) a B2B send queue 1350, (6) M2B send queue 1360, (7) a beacon queue 1370, (8) a MAC Layer Scheduler 1380, and (9) a time synchronization manager 1390. In other implementations of the invention, two or more modules may be combined into a single module, or any one module may be divided into multiple modules.

Neighbor table 1310 maintains a list of active and reliable neighbors. Neighbor table management module 1315 maintains a list of active and reliable neighbors. Routing table 1320 provides candidates for the next hop for the destination display node or the gateway node via routing manager 1325. The routing manager looks up the routing table for candidates for the next hop bridge node, or gateway node. Child sensor node table 1330 stores the latest event reported by each child sensor node. Sensor-bridge communication manager 1335 manages communication between the child sensor node and the bridge node. Child permit node table 1340 stores the latest information reported by a child permit node. Permit-bridge communication manager 1345 manages communication between the permit sensor node and the bridge node.

For each new child sensor or permit node based event that needs to be propagated further into the network the routing manager creates a new packet and adds it to the B2B send queue. B2B send queue 1350 prioritizes packet transmission to next hop bridge neighbors or gateway node. M2B send queue 1360 prioritizes packet transmission to child sensor and permit nodes. The beacon send queue 1370 prioritizes packet transmission for beacon broadcast messages. MAC layer scheduler 1380 manages data packet transmission. Time synchronization manager 1390 synchronizes the sleep/wake schedules of the sensor nodes and the bridge nodes, as to enable MAC layer scheduling.

Additionally, for each child sensor node, the parent bridge issues a query to the central server to learn about the set of bridge nodes and display nodes that must be updated when the child sensor node detects a change in the occupancy of a parking space. When a parking space becomes available, the occupancy change event is transmitted by the parent bridge node to the relevant bridge nodes. These bridge nodes then update their child permit node tables and clear out any cached entries containing credentials for that parking space. Additionally, when a sensor node detects a change in occupancy status of a parking space, the parent bridge node multicasts a message to the destination display nodes so that they may update their counts.

Network packets received at the bridge node from other bridge nodes, display nodes, or gateway nodes are processed by the routing manager and may be further forwarded to the next hop bridge node, or display node, or gateway node based on the packet. The next hop candidates are retrieved from the routing table. Entries in the routing table are updated based on the current neighbor table. Once the next hop node is determined, a data packet is created and the packet is buffered in a send queue for future transmission. Routing protocol packets destined for a child sensor nodes are sent to the sensor-bridge communication manager for further processing. The sensor-bridge communication manager processes the packet and adds it to the M2B send queue for transmission to the appropriate child sensor node. Similarly, routing protocol packets destined for a child permit nodes are sent to the permit-bridge communication manager for further processing. The permit-bridge communication manager processes the packet and adds it to the M2B send queue for transmission to the appropriate child permit node.

The send queues prioritize packet transmission based on packet priority or the order of arrival in the send queue. Packets for common next hop neighbors are aggregated or transmitted back to back when the transmission window is available.

Due to the variations in the clock crystal frequency on the node, it is common for local time at neighboring nodes to drift with respect to each other with time. Over a period of time, the time drift between nodes may be too large for accurate MAC layer scheduling. In one implementation, the time synchronization requirements are not very stringent and a scalable, distributed and low overhead time synchronization algorithm provides coarse time synchronization among nodes in a particular neighborhood. In other implementations, the time synchronization may be more stringent and use a different algorithm.

Permit nodes dynamically enter and leave the network. Upon entering the network, permit nodes run a network discovery protocol to populate the neighbor bridge node table with neighboring bridge nodes. The permit-bridge communication manager at the bridge node also synchronizes the time between the permit node and the bridge node. Additionally, the bridge node sends the permit node a location based beacon message via which the permit node learns about the physical coordinates of the bridge node as well as records the received signal strength (RSS) of the messages from the bridge node.

In one embodiment, the permit node can continue to listen for location-based beacon messages from other nodes to help with its location estimation. A location-based beacon message is transmitted periodically by a sensor node or a bridge node and it contains a time stamp and the actual physical coordinates of the node. The permit node records the received signal strength (RSS) of the message as well as the physical coordinates of the node.

A permit node selects the bridge node with best link quality as the parent bridge node. The Credentials Manager in the permit node generates an event to send its credentials as well as estimated location to the parent bridge node. This event includes the permit node identifier, permit credentials, the permit expiration date, the permit node's estimated location, and the vehicle identifier (optional).

The event transmission from the permit node is sent to the Permit-Bridge Communication Manager in the parent bridge node. After event transmission, the permit node waits for an acknowledgement packet (ack) from the bridge node. If the permit node fails to receive an acknowledgement packet within an acknowledgement packet timeout interval, the permit node will retransmit the event packet. Time synchronization occurs at the permit node to ensure reliable scheduling of the M2B frames. The parent bridge node is responsible for sending time synchronization messages to the child permit node to make sure the permit node's local time does not drift away from the bridge's local time.

Media Access Control (MAC) Layer Scheduler

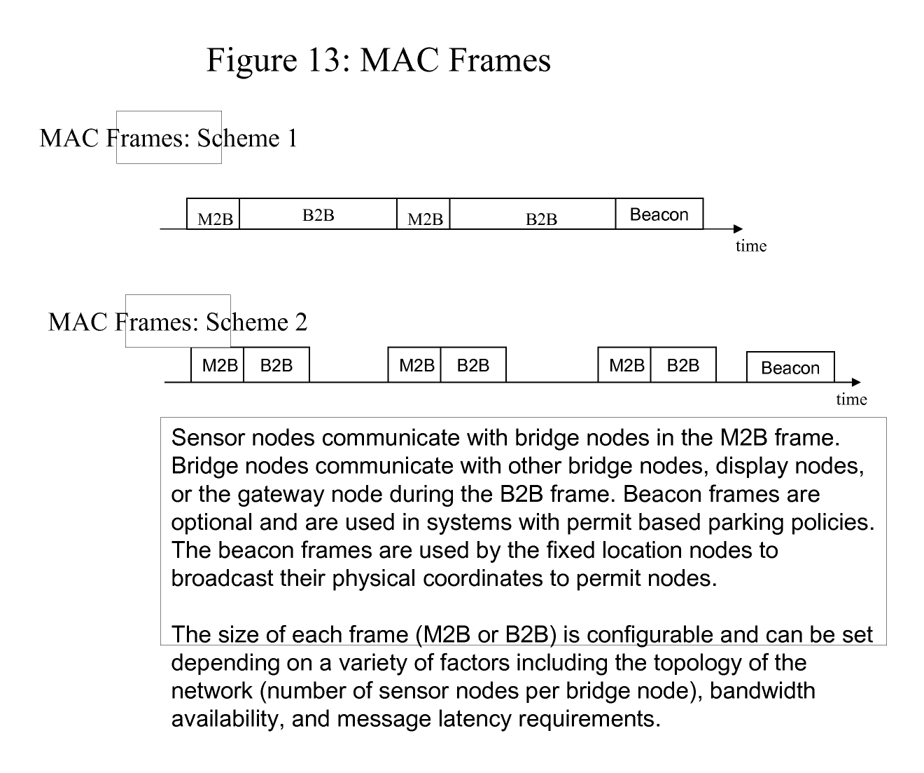

FIG. 13 shows two timing diagrams for different MAC frames. In scheme 1, at the MAC layer, time is divided into recurring time frames. The mote-to-bridge (M2B) frame is dedicated for communication between sensor nodes and bridge nodes, and between permit nodes and bridge nodes. The bridge-to-bridge (B2B) frame is dedicated for multihop data routing between bridge nodes, display nodes, and gateway nodes. As shown in scheme 2, in an implementation of the invention that includes permit-based parking policies, the MAC scheduler may include an optional beacon frame as a third communication frame. The beacon frames are used by the fixed location nodes (sensor nodes or bridge nodes) to broadcast their physical coordinates to permit nodes. The size of each frame (M2B, B2B, or beacon) is configurable and can be set depending on a variety of factors including the topology of the network (number of sensor nodes per bridge node), bandwidth availability, and message latency requirements.

In one implementation, a MAC layer scheduler at the sensor nodes and bridge nodes implements the MAC layer communication frames shown in scheme 1. In another implementation, the MAC layer scheduler may implement the communication frames in scheme 2. In yet another implementation, the MAC layer scheduler may implement a set of frames different from scheme 1 or scheme 2.

In general, a node may switch off its radio to conserve power if it does not need to communicate (send or receive messages) during a certain time interval. For example, sensor and permit nodes can switch off their radios during B2B frames to conserve power. Additionally, other nodes may turn off their radios based on the communication frames used in the MAC layer. For example, in the MAC layer scheme 2 shown in FIG. 13, all nodes can turn off their radios when the M2B, B2B, and beacon frames are not active.

There are advantages of the MAC layer packet transmission scheduling. For example, during the M2B frames, bridge nodes are guaranteed to be in a listen state to receive messages from sensor and permit nodes. Similarly, permit nodes can expect to receive broadcasted beacon messages during the beacon frame. Additionally, during the M2B frames, sensor nodes only compete with other sensor and permit nodes in their neighborhood in transmitting packets to the bridge nodes. They do not have to compete with traffic at the bridge layer. This scheduling facilitates a simple MAC that ensures packets from neighboring sensor and permit nodes do not collide with communication occurring within the bridge layer during the M2B frame.

MAC Layer for M2B Frame

In one implementation, the slotted ALOHA protocol is used in M2B frames. At the MAC layer, sensor and permit nodes that have detected an event to report compete with other sensor and permit nodes in their radio range to send messages to the bridge layer during the M2B frames. The event generation rate depends on the activity in the parking lot or the number of cars entering or exiting the neighborhood of a bridge node listening for sensor and permit nodes in its radio range. If the parking spaces are close to each other, the sensor and permit nodes would be densely deployed but only a small percentage of them may actually have an event to report concurrently in a given M2B frame. Among the competing sensor and permit nodes, the load is further distributed by the multiple bridge nodes in their local neighborhood. Therefore, the total number of packets generated in a given M2B frame for particular bridge node is a small fraction of all sensor and permit nodes within its radio range. In short, the rate of MAC layer collision at the receiver bridge node is inherently low due to low event generation rate and the redundancy of bridge nodes in the local neighborhood.

A simple MAC solution such as the slotted ALOHA protocol, which relies on randomization to avoid collisions, is effective even in peak traffic conditions. Slotted ALOHA has minimum overheads and is proven to have high throughput efficiency in low traffic conditions. The sensor and permit nodes receive a random slot number for future transmissions from the bridge node in the acknowledgement packet (ack) of a transmission. The slot size is equal to the round trip delay of a packet transmission. The data transmission and the corresponding acknowledgement packet reception is an atomic operation.

For a sensor or permit node, if the transmission fails due to failure in receiving acknowledgement packet, the data transmission is scheduled for the same slot in the subsequent M2B frame. Bridge nodes simply listen for incoming event messages from sensor and permit nodes and generate appropriate acknowledgement packet messages.

In other implementations, other network control protocols may be used at the sensor and permit nodes, such as ALOHA, carrier sense multiple access (CSMA), carrier sense multiple access with collision detection (CSMA/CD), carrier sense multiple access with collision avoidance (CSMA/CA), carrier sense multiple access with bitwise arbitration (CSMA/BA), IEEE 802.11 RTS/CTS, and others.

MAC Layer for B2B Frame

In one implementation, CSMA/CA is used in the B2B frame. Since the properties of the bridge layer are similar to traditional wireless ad hoc network, the bridge layer MAC uses an adapted CSMA/CA protocol to resolve contention while routing during the B2B frame. CSMA/CA is a cost effective and stable MAC solution for a low data rate network, where the packets are small. For transferring larger packets, the MAC protocol is a CSMA/CA with request to send/clear to send (RTS/CTS). RTS/CTS mechanism by which the sender node broadcasts a request to send message and the receiver node sends a clear to send message to warn their neighbors about an ongoing packet transmission and its duration.

The RTS/CTS mechanism solves the hidden terminal problem, where collisions of packets occur at the common receiver node because different sender nodes outside of each other's communication range and unaware of the each other's transmission, transmit packets at the same time. The hidden terminal problem can lead to low throughput during large packet transmissions. At the send queue, if there are multiple packets outstanding for a given next hop bridge node, RTS/CTS enabled data transmission disables individual acknowledgement packet to improve packet throughput on a per hop basis. A module that merges multiple packets for the same next hop (receiver node) into a single larger data packet to reduce the overall overhead associated with individual data packets optimizes the RTS/CTS mechanism. Another module that splits large packets into original individual packets for separate processing and routing to their corresponding sinks at the receiver node further complements the mechanism.

In other implementations, other network control protocols may be used at the bridge nodes, such as ALOHA, carrier sense multiple access (CSMA), carrier sense multiple access with collision detection (CSMA/CD), carrier sense multiple access with collision avoidance (CSMA/CA), carrier sense multiple access with bitwise arbitration (CSMA/BA), IEEE 802.11 RTS/CTS, and others.

MAC Layer for Beacon Frame

In one implementation, the beacon frame is divided into multiple time slots. Each time slot is sufficiently long enough to support the transmission of a single beacon message. The sensor and bridge nodes that are set up to send out beacon messages are configured to send their beacon message at a particular time slot within a beacon frame. These nodes are configured so as to uniformly distribute beacon messages throughout the parking facilities.

Time Synchronization

In an implementation with a distributed environment, it is essential for the clocks of nodes in a neighborhood to be synchronized to enable MAC layer scheduling, and to synchronize the sleep/wake schedules of the sensor, permit, and bridge nodes. Since all hardware clocks are imperfect, local clocks of nodes may drift away from each other in time, hence observed time or durations of time intervals may differ for each node in the network.

Additionally, the clock crystal frequency may be affected by environment factors, such as temperature, pressure, battery voltage, and others. In an implementation, the MAC layer scheduling does not require stringent time synchronization. Loose time synchronization among neighboring nodes is sufficient. The MAC layer adopts distributed time synchronization, such as asynchronous diffusion protocol (see Q. Li and D. Rus, “Global Clock Synchronization in Sensor Networks,” Proc. IEEE Conf Computer Communications (INFOCOM 2004), v. 1, 564-74, Hong Kong, China, March 2004), which is more cost effective than global clock synchronization algorithms.

Distributed time synchronization trades off the time synchronization precision achieved by algorithms with the associated communication and processing overheads. The system initiates a network-wide, controlled flood at the gateway node that propagates through the entire network to resynchronize the local time at bridge nodes to the system time at the gateway node. Nodes that fail to receive a gateway node initiated time synchronization packet within the expected interval trigger a self-timer based synchronization protocol, and initiate synchronization packet exchanges in their local neighborhood.

Time synchronization messages are proactive control messages that are exchanged periodically. The parent bridge nodes send time synchronization messages to their child sensor or permit nodes as part of the acknowledgement packets for any communication initiated by the sensor or permit nodes. Thus the sensor and permit nodes check their local clock drift by periodically updating their local time to their parent bridge node's system time.

In other implementations, time synchronization may be achieved with Cristian's algorithm (see F. Cristian, “Probabilistic Clock Synchronization,” Distributed Computing 3:146-158, Springer-Verlag 1989), flooding time synchronization algorithm (see Miklós Maróti, Branislav Kusy, Gyula Simon, and Ákos Lédeczi, “The Flooding Time Synchronization Protocol,” Proceedings of the 2nd International Conference on Embedded Networked Sensor Systems 2004), reference broadcast synchronization (see J. Elson, L. Girod, and D. Estrin, “Fine-Grained Time Synchronization Using Reference Broadcasts” in Proceedings of the Fifth Symposium on Operating Systems Design and Implementation (OSDI 2002), Boston, Mass., December 2002), Timing-Sync Protocol for Sensor Networks (S. Ganeriwal, Ram Kumar, and M. Srivastava, “Timing Sync Protocol for Sensor Networks,” ACM SenSys, Los Angeles, November 2003), and Internet Network Time Protocol (NTP).

Neighborhood Management

In an implementation, the neighbor table at a bridge node has a list of all active bridge nodes in the neighborhood. The neighbor table is dynamic in nature and it is affected by node or link failure. Node failure is rare for bridge nodes but the temporal link quality is variable in low power, short range wireless networks. The link quality varies with time depending on weather conditions, temporary physical obstructions in the environment, antenna orientation, fading characteristics, and physical separation from its bridge nodes neighbors. In other implementations, the neighbor table may be combined with other tables in the bridge node, such as the routing table, or the neighbor table may be divided into two or more tables. In another implementation, the neighbor table may not be dynamic and not affected by node or link failure.

The neighbor table stores all the one hop bridge node, display node, and gateway node neighbors of the given bridge node, as long as their associated estimated link quality index is greater than a threshold level that indicates stable bidirectional connectivity. The neighbor table also stores parameters such as packet error rate and spatial coordinates of each bridge node. The periodic time synchronization messages could be used to indicate the latest connectivity status among neighbors.

While routing, there are neighbors that do not yield a valid route after several hops due to the current network topology. A parameter known as the route error rate determines the effectiveness of a neighbor in yielding a stable multihop route to the destination node. Neighbors with high route error rates that consistently fail to yield valid routes through themselves are gradually evicted from the neighbor table. The goal of neighborhood management is to estimate the reliability of neighbors at the bridge layer in order to improve the probability of end-to-end packet delivery.

Sensor-Bridge Communication Manager

In an implementation, the Sensor-Bridge communication manager is responsible for all communication between a bridge node and its child sensor node. Radio communication at sensor nodes is switched off during the B2B frame. If a sensor node detects any events during a B2B interval, they are reported to the parent bridge node during the following M2B interval. The sensor-bridge communication manager is active during the M2B interval. Besides event packets, sensor nodes also generate health messages periodically to update the central server, such as the residual battery level, and any sensor malfunction. The frequency of the health messages is very low and they are routed to the gateway node to update the central server. If there are any pending data packets containing health or event data to be sent during the M2B frame, the sensor-bridge communication manager implements the slotted ALOHA MAC schedule packet transmission. It then waits for an acknowledgement packet from the bridge node. If none is received, the sensor node times out and retransmits the packet in the subsequent M2B frame.

At the bridge node, packets from the sensor nodes are processed into data packets and are handed over to the routing manager to be forwarded towards the respective display nodes, bridge nodes, or gateway node. The child sensor node table at the bridge node maintains the most recent event update received from the child sensor nodes. Such redundancy of information at parent bridge nodes is important to retransmit the latest events if data is lost while routing.

Permit-Bridge Communication Manager

In an implementation, the permit-bridge communication manager is responsible for all communication between a bridge node and its child permit node. Radio communication at permit nodes is switched off during the B2B frame. The permit-bridge communication manager is active during the M2B interval. If there are any pending data packets to be sent during the M2B frame, the permit-bridge communication manager implements the slotted ALOHA MAC schedule packet transmission. It then waits for an acknowledgement packet from the bridge node. If none is received, the permit node times out and retransmits the packet in the subsequent M2B frame.

At the bridge node, packets from the permit nodes are processed into data packets and are handed over to the routing manager to be forwarded towards the respective gateway node. The child permit node table at the bridge node maintains the most recent event updated received from the child permit nodes. Such redundancy of information at parent bridge nodes is important to retransmit the latest events if data is lost while routing. A cached child permit node table entry is cleared after the vehicle containing the permit node vacates its parking space.

Network Routing

Bridge layer plays a major role in routing. In one implementation, all the data communicated to bridge nodes from the sensor nodes and permit nodes is one-hop and is handled by the appropriate communication manager and the MAC scheduler as described in a previous section. Bridge nodes also route data from bridge nodes to other bridge nodes, display nodes, and the gateway nodes. In another implementation, bridges may not exist and sensor and permit nodes may form a mesh network among themselves and transmit messages to display nodes and gateway nodes.

In one implementation, here is the pseudocode for the routing protocol:

(i) Every node maintains a cache of next hop information for every destination to which it has forwarded packets successfully.

(ii) Node A receives a message from node C, to be forwarded to node D.

(iii) Node A checks its cache to see if there is an entry for the corresponding destination.

(iv) If there is a cache entry for the destination, the packet is sent to the next hop, node B, stored in the cache.

(v) If there is no cache entry for the destination, the node chooses a neighbor, node B, from its neighbor table, which is closest to the destination and has good link quality with respect to node A.

(vi) The node A forwards the message to node B.

(vii) Node B follows the same algorithm and tries to forward the message.

(viii) If node B could not forward the message through all possible routes, it backtracks and sends the packet back to node A.

(ix) On receiving the backtracked message, node A removes the entry corresponding to node B (for that destination) from its cache, if the entry was already present.

(x) On receiving the backtracked message, node A tries to forward the message to the next closest node with good link quality.

(xi) If node A is unable to forward the message to the destination via neighbors closest to the destination with good link quality, it tries to send the message to a node with poor link quality which is closer to the destination.

(xii) After exhausting all neighbors closer to the destination node A backtracks and sends the message back to node C.

(xiii) The cache is updated on every successful or failed delivery by changing the next hop information suitably.

In one implementation, the routing protocols estimate the temporal link quality, packet error rate, and route failure rate of neighbors in real-time at the neighbor table. So, the protocols could select more reliable neighbors as potential packet forwarders and avoid lossy links. There is a per hop implicit hardware acknowledgement exchanged for each successful data transmission. If the acknowledgement wait timer expires at the sender node and the acknowledgement packet is not received, the data packet is retransmitted. If a next hop fails to yield a valid path at any intermediate bridge node between the source and the destination node, then intermediate node intelligently reroutes the packets through an alternate route. The routing protocols are robust enough to establish alternate routes when primary routes fail due to unpredictable node or link failure. For critical packets such as configuration packets, end-to-end acknowledgement packets could confirm data delivery and ensure that all nodes are properly configured in the bootstrap phase.

In one implementation, the routing protocol is designed to be scalable to support thousands of nodes. Instead of running centralized algorithms to compute optimal path in network graph connecting source destination pairs, the protocol uses localized algorithms that use only local neighborhood information to discover routes. Since the network topology varies with time owing to transient link failures and interference, it is expensive to update the network topology at a central base station on a global scale in real-time. Real-time knowledge of immediate neighbors is used to compute next hop nodes, while routing to keep computation and communication overheads of the routing protocol low for better scalability.

In one implementation, the routing protocol uses knowledge of bridge node parameters such as their location or spatial coordinates in the field to aid routing. Knowledge of the locations of destination nodes and neighbors helps the routing protocol to make routing related decisions in a localized manner.

In one implementation, the routing protocol avoids routing loops to avoid wasting network bandwidth and resources. Otherwise, the system may lose packets and packet throughput will reduce causing more traffic congestion in the network. The routing protocol may use location aided routing to completely avoid formation of routing loops. The routing protocol ensures that the packets are consistently routed in the direction of the destination, such that the next hop is always closer than the current hop to the destination. By adopting this routing logic, a node will never visit a node already visited during its journey towards the destination node, which eliminates the likelihood of loop formation.

The routing protocols in the networking software vary depending on nature of data collection or reporting applications. The most prominent kind of routing application is any-to-any routing among the bridge nodes, display nodes, and gateway nodes. Other routing applications include aggregation trees to collect network health and management data from the bridge and sensor nodes. The time synchronization uses a network wide controlled flooding approach initiated at the gateway node since all nodes participate in this protocol. Occasionally, data dissemination protocols from the root disseminate commands or configuration parameters to the entire network or specific nodes in the network.

For each child sensor node, a bridge keeps a list of display nodes that need to be updated when the child sensor node detects a change in parking space occupancy. The bridge node queries the central server to get access to the list of display nodes. At run time, the event data from parent bridge nodes is routed towards the respective display nodes to update their availability counts in real time.

A bridge node keeps a list of other bridge nodes that need to be updated when its child sensor node detects a change in parking space. The bridge node queries the central server to get access to this list of other bridge nodes. At run time, the event data from parent bridge nodes is routed towards the other bridge nodes to help them update their child permit tables appropriately.

In one implementation, bridge nodes are aware of the locations of other bridge nodes, display nodes, and gateway nodes. The neighbor table in the bridge also has the location of the neighboring nodes. The protocol uses geographic forwarding as a form of location based routing. Geographic routing accommodates the case of 3-dimension node coordinates generated on the basis of the field network deployment.

In one implementation, the routing protocol may use geographic forwarding wherein each node decides its next hop based on selection of a reliable neighbor whose Euclidean distance is closer than itself to the destination node. This routing logic is executed at each intermediate bridge node beginning from the source bridge node until the destination node is one hop away from any intermediate node on the route. Advantages of geographic forwarding are natural avoidance of routing loop formation and low computation and memory overheads. A local minimum results when an intermediate node is not able to find any neighbor closer to the destination. If a node gets stuck at a local minimum while executing the greedy forwarding function, the packet may retrace its path and attempt geographic forwarding from a previous node in the forward path. This may lead to discovery of an alternate connected route in a direction different from the initial route.

One implementation may use strategies to determine the boundary of the voids in the network, where voids are bounded regions in the network devoid of any connected nodes. Instead of back tracking, the routing protocol may also implement an algorithm that routes the packet along the boundary of the void to reach the destination in a deterministic manner.

In one implementation the routing algorithm may use a distributed algorithm proposed by Fang, et al (see Qing Fang, Jie Gao, and Leonidas J. Guibas, “Locating and Bypassing Holes in Sensor Networks,” The 23rd Conference of the IEEE Communications Society (INFOCOM), v. 23, n. 1, 2458-68, March 2004), to build routes around holes, which are connected regions of the network with boundaries consisting of all the stuck nodes.

In one implementation, bridges may multicast an update from a child sensor node to other bridge nodes display nodes, and gateway nodes to help them update their child permit tables accordingly. Multicasting is effective as it reduces overheads associated with unicasting and helps reduce the energy and bandwidth required to send the information to the destination nodes.

One implementation the system collects network management data from the entire network and updates the central server periodically. An aggregation tree could span all nodes in the network with the root of the tree as the gateway node. Instead of using any-to-any routing between each node and the gateway node that connects to the root node, an aggregation tree could eliminate or reduce congestion near the gateway node created by several independent packet flows.

There are several ways to construct aggregation trees, such as spanning trees, depth first or breadth first trees. All nodes could keep track of number of hops they are away from the gateway node through the periodic messages. This enables bridge nodes that are farthest from the root node, or leaf bridge nodes, to select one bridge node from their neighboring bridge nodes which are fewer hops away from the root. Bridge nodes may select the next hop bridge node with the best link quality over time to increase reliability or stability of the aggregation tree. The aggregation tree is thus built in a bottom up manner and dynamically adapts to random link failures in the network.

In one implementation, the routing protocol may broadcast information or a command initiated by a node to a certain set of nodes in the network. For example, the packets related to time synchronization could span across the entire network periodically. Similarly, control commands such as initialization or updating of configuration parameters, sensing frequency or shutting down of parking lot may need to be communicated to a set of nodes in the network. The system may use a simple controlled flooding scheme to propagate time synchronization messages in the entire network. Propagation of special commands and control packets issued by the administrator at the central server may be accomplished by either piggybacking the control packet on time synchronization messages or initiating another controlled flood in the entire network

Queue Management

In one implementation, “send queues” at the bridge node buffer outstanding packets from different elements like the time synchronization manager, the routing manager, the sensor-bridge communication manager, and the permit-bridge communication manager. The send queue interfaces with the MAC layer to schedule physical transmission of packets and buffers them until it receives an acknowledgement packet from the next hop. If the send queue fails to receive an acknowledgement packet from a packet transmission, it times out and re-transmits the packet. There are two send queues at the bridge node, one to handle bridge layer traffic during B2B MAC frame, called the B2B send queue, and another for communication with the sensor nodes during M2B frame, called M2B send queue.

When permit based parking policies are implemented, the bridge node is configured with its physical coordinates and its time synchronization manager generates beacon events. These beacon events that need to be broadcast and they contain a time stamp and the physical coordinates of the sensor node. These events are put into a beacon queue and the MAC scheduler schedules the transmission of these beacon events during a predefined time slot during a time interval called the beacon frame in the MAC layer.

In one implementation, during heavy network traffic conditions the rate of packet transmission could be slower than the rate of packet generation due to MAC delays. Therefore packets are buffered while the node contends for a MAC channel. Send queues not only buffer data, they also handle packet transmission based on priority and facilitate the MAC layer protocol and optimizations. Different packets could be assigned different priorities. For example, configuration parameters sent by the root to all nodes and event data generated by source bridge nodes could be the most critical data packets, whereas network health and time synchronization messages have lower priority. Once the physical channel is clear for packet transmission, the packets with highest priority are transmitted first. Therefore, the send queue buffers packet in the descending order of their priority. Packet priority could depend on a variety of factors including: (a) packet type, (b) number of outstanding messages for the same next hop, (c) time elapsed since packet was enqueued.

Data Management

In one implementation, as shown in FIG. 12, there are various data structures or tables that store information at nodes. There are tables related to configuration parameters. At run time, the neighbor table is formed and updated using periodic messages. The child sensor node table stores the latest events from sensor nodes. The child permit node table stores the latest events from permit nodes. The routing table stores potential next hop candidates for various destination display and gateway nodes. The display nodes store latest events from member sensor nodes. This distributed information is constantly overwritten by real-time data exchanged among the nodes which include sensor nodes, permit nodes, bridge nodes, display nodes, and gateway nodes.

All data structures related to neighborhood management, routing, sensor node to bridge communication, permit node to bridge node communication, and queue handling share the finite storage space available at a node. In one implementation, smart insertion and eviction schemes are used for optimal use of the node memory. Unwanted or stale entries are promptly evicted from data storage tables and only the most relevant entries remain. A good example of data management at bridge node level is neighborhood management.

Besides data management for data structures used in various nodes, provisions exist for limited caching or logging. The source bridge nodes log the latest events to enhance reliability of message routing by initiating a retransmission of event data from the source bridge node to its destination display or the gateway node if the original message is not delivered successfully. Limited logging or caching at the bridge node stores some of the recent packet routes observed by the bridge node. Such route caching is useful for a fall-back mechanism for alternate path routing, when packets need to retrace their paths. The node's permanent storage has a log of the configuration parameters so that they are never destroyed in case of temporary node failure. The node on revival can rely on the logged configuration parameters to reconnect to the wireless network.

Aggregation

In one implementation, the system uses in-network aggregation and processing of data to reduce communication overheads at the cost of increased computation overheads for large scale monitoring of parking spaces through wireless networks. Data aggregation may be performed in a spatial or temporal manner. Bridge nodes may collect and combine events generated from multiple sensor and permit nodes for the same destination over a period of time.

If the data reported to a sink is an accumulation of readings generated by nodes belonging to a particular region of the network, it is more optimal to combine them close to the source of the information as possible, than to aggregate them at the sink. Therefore, local aggregation schemes to aggregate and combine sensor and permit node data meant for the same sink reduces the total volume of data sent out of the network. In-network processing trades processing overhead with communication overhead to save the overall consumption of network resources. Similarly, health diagnostic data collected from the entire network is transmitted through suitable aggregation trees to save network routing overhead and promote data piggybacking or combining at the MAC level to reduce channel contention at the link layer.

Network Configuration

In one implementation the system operates unattended for its entire lifetime. Therefore, it is essential to configure the nodes properly so that they can resume normal operations once nodes restart after temporary failures. The central server provides the configuration parameters that are used to set the node and to support its run time behavior. These are parameters that describe the specific node's properties such as its location, MAC window frames, sensing frequency and threshold sensor values, and so forth. The configuration parameters are usually stored in permanent storage area so that in case of node failure the node can restart enter the bootstrap phase, and reconnect to the network.

Design of Parking Revenue Management System Integration

In one embodiment, the central server integrates with a parking revenue management system to receive the payment information associated with each parking transaction. After a visitor makes a payment for using a parking space the parking revenue management system sends this information to the central server. The information sent by the parking revenue management system may include an identifier for the parking space, the amount of money paid, and the valid parking duration.

In one embodiment, the parking revenue management system may consist of a software server that receives payment related information from one or more payment nodes. Examples of payment nodes include parking meters or parking pay-by-space machines. In another embodiment, the parking revenue management system may consist of a cell-phone based revenue management system.

In one embodiment, the central server may integrate with the parking revenue management system via a SOAP based software application programming interface (API). This API facilitates could allow for the central server to query the parking revenue management system for payment information. Additionally, the API could allow the parking revenue management system to proactively send payment information to the central server in real-time as and when the parking revenue management system receives payments or payment related information from visitors.

Design of Parking Policy Violation Detection

Administrators define parking policies in the system and associate them with parking spaces. Each parking space may have one or more parking policies that need to be monitored to detect any violations. These parking policies and their association with parking spaces is stored in a central database.

Upon startup, the central server loads all the parking policies in the system. As mentioned earlier, the sensor and permit data from the parking lot is routed to a central server via the wireless network of sensor, permit, bridge and gateway nodes. The central server receives all this information and analyzes it to detect parking violations.

In one implementation, the parking policies may be modeled as business rules and the central server may use a rule engine such as by ILOG Technology to execute them. Streaming data from the network is continuously fed into the rule engine and the rules are evaluated to detect any violations. For each parking space, the parameters the system continuously tracks include the following:

(1) Occupancy(P) denotes the occupancy status (occupied or available) for parking space P.

(2) Time(P) tracks the time of latest vehicle arrival in parking space P.

(3) Duration(P) tracks the duration the parking space has been available or occupied.

(4) Credentials(P) tracks the credentials of the vehicle parked in space P for permit based parking spaces.

(5) AlertStatus(P) counts the number of violation alerts that have been raised for the duration that a vehicle is parked in space P. AlertStatus(P) is reset to zero when there is no vehicle parked in space P.

Here are some examples of the rules that can represent parking policies:

(1) No parking anytime policy being applied to parking space P.

(2) If (Occupancy(P)=Occupied) and (AlertStatus(P)=0) then raise an alert.

(3) Maximum 30 minute parking at parking space P.

(4) If (Occupancy(P)=Occupied) and (Duration(P)>30 minutes) and (AlertStatus(P)=0) and (Grace Period has expired) then raise an alert.

(5) Reserved Permit “A” required to park at P.

(6) If (Occupancy(P)=Occupied) and (Credentials(P) not equal to “A”) and (AlertStatus(P)=0) and (Grace Period has expired) then raise an alert.

The AlertStatus of a parking space is incremented by one each time an alert is raised for the parking space. A parking administrator can choose to continuously enforce a parking policy on a violating vehicle and configure the system to raise alerts in a recurring fashion if the vehicle continues to violate the parking policy.

Upon identifying a violation, the central server begins processing the alerts that need to be delivered. As described above, an alert may be issued to one or more enforcement officers based on a variety of factors including, but not limited to, the following: geographic location or zone of parking space where the violation occurred; type of violation; time of violation; workload on enforcement officer; location of enforcement officer; past history of alerts issued to the enforcement officer; performance of the enforcement officer, and other factors.

These alert definitions can also be modeled as business rules and a rule engine like ILOG can be used to process them. After these rules have been evaluated, the alerts are sent out to the appropriate parking enforcement personnel. Here are some examples that can be evaluated while issuing alerts:

If (parking space=P1) then issue the alert to John Fiorda.

If (parking space=P1) and (violation time occurs in the morning shift) then issue the alert to Jamie Oram.

Design of Policy Violation Notification and Reporting

Once a violation is detected, the system issues the appropriate alerts. Alerts are typically sent to alert devices that are carried by parking enforcement officers. The alert messages can be displayed in a user-friendly manner as text messages providing details qualifying the specific violation alert. Additionally, an alert device may also ring or beep to notify the enforcement personnel of an incoming alert message. The parking violation alert details can be displayed on alert devices like PDAs, cell phones, e-mail clients, SMS clients, display screens on vehicle dashboards, etc. Additionally, the alert details may also be sent to another system that receives them based on an API.

There are different types of alert messages. These message types include, but not limited to, the following:

Parking violation alert: these messages are sent out to notify enforcement personnel of a parking violation. Among other information, this message includes a violation identifier, the parking space identifier, time of violation, and type of violation.

Citation confirmation alert: this message is sent by a parking enforcement officer to the system to confirm that he/she has processed the parking violation. Among other information, this message includes the violation identifier, time of enforcement, citation fine, and the parking enforcement officer identifier.

Violation termination alert: these messages are sent out to notify enforcement personnel that the vehicle violating a parking policy has vacated its parking space or the parking violation has already been processed by another enforcement officer. In addition to other information, this message includes the violation identifier, and the time of termination.

Sometimes there may be delay from the time the central serve issued an alert to the time a parking enforcement officer reaches the parking space with a potential violation. Therefore, in addition to alert messages, parking enforcement officers may carry tools to enable them to query the central server to obtain information about the currently parked vehicle such as its time of arrival, duration of parking, credentials, etc. These tools help the parking enforcement officer confirm that the parked vehicle is the one that violated a parking policy.

Design of Parking Activity Reporting and Analysis

Users can view the monitoring console to view the parking lots in real-time. The system could also provide elaborate reports on historical parking activity and perform deep analysis to gain insights into parking operations. The application provides novel real-time views of all the parking areas and allows the user to zoom in and out of parking facilities while being able to view the occupancy status of each parking space. Spaces are depicted in different colors based on the length of time they have been occupied or available.

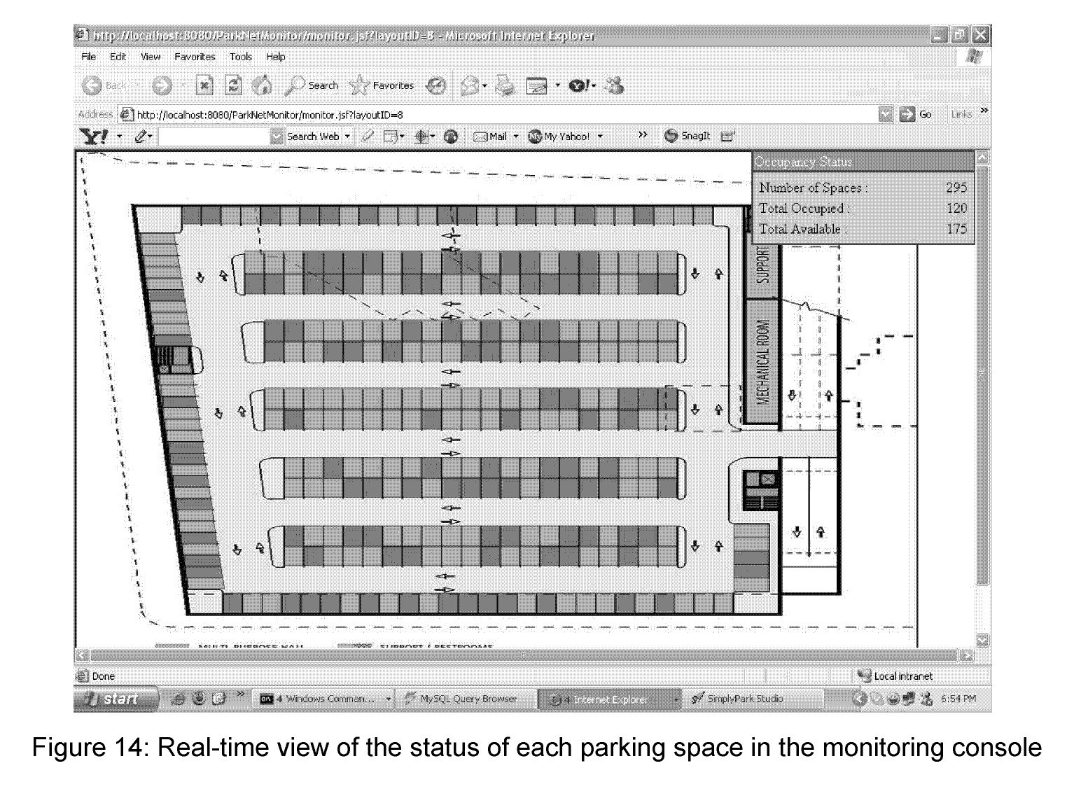

For example, FIG. 14 shows a computer screen of a monitoring console. Spaces that have been occupied can be configured to be displayed in red, and spaces that have been available for a while can be displayed in green. Parking spaces with vehicles that are violating parking policies can be configured to be shown in grey. Any other desirable color or graphical scheme may be used. The screen shows a real-time graphical view of the status of spaces in a parking lot. Further, the user can move a pointer (such as a mouse) to hover over a space, and then a message will pop up on the screen to show the user how long the space has been occupied or vacant. The user may select a space and click to obtain a listing of the occupancy history of a space.

The central database records fine-grained historical information related to parking operations including data relating to parking occupancy, policy violation, enforcement personnel activity, and so forth. The system processes this information and generates elaborate reports containing a variety of parking related metrics with actionable insights which allow parking managers to take effective steps to improve their operations. For example, managers can view the following metrics for any particular set of parking spaces (e.g., an entire facility, a particular layout, an aisle, a particular space) over different periods of time (e.g., yesterday, last week, current month, this year, and so forth):

(1) Number of parking transactions (i.e., number of vehicles that parked in the set of spaces during the time period).

(2) Average duration of parking. This metric is evaluated by summing the duration for which each vehicle was parked and dividing this sum by the number of parking transactions.

(3) Percentage parking space utilization. This metric is evaluated by summing the duration for which each vehicle was parked and dividing this sum by the total available parking time across all the spaces in the set of parking spaces during the period being considered.

Specifically, analyzing historical information related to parking violations is important for a number of reasons. Parking personnel can judge the effectiveness of citation revenue collection based on the total number of citations issued. Managers can analyze the effectiveness of the enforcement personnel by reviewing the number of violations they cite versus the number that are issued to them. Additionally, parking managers can observe if their parking policies are effective by analyzing the rate at which parking violations incidents and citations fall or increase with time.

The system supports browser based views at monitoring consoles to show current or past parking violations at parking spaces. Access privileges are assigned to authorize parking facilities personnel for accessing these views on the monitoring consoles. Analysis of parking activity at parking spaces and associated policies that are violated more often than others can lead to a better understanding of commuter behavior and utilization patterns of the parking facility. Additionally, new parking policies may be defined based on this understanding to facilitate the fair, safe, and equitable use of parking facilities. For example, a few five minute parking spaces close to the add/drop box of a library may prevent parking in unmarked areas for a quick trip to return books at the library.

Design of Parking Guidance Information Dissemination

In one implementation, the primary guidance information dissemination device is the display node installed at the intersections in parking lots to guide visitors to available parking spaces by messages flashed onto the display screens. In another implementation, the system could provide parking information and guidance to visitors through their cell phones, PDAs, via browsers, or vehicle dashboards, or other devices.

In one implementation, light emitting diodes (LEDs) may be installed on the ceiling or walls above each parking space. These LEDs may be turned on or off depending on the occupancy status of the space. Visitors to a parking facility may look up to quickly identify the specific parking space that is available. In another implementation, a red and a green LED may be mounted on top of each parking space. If the space is occupied, the red LED is active and the green LED is inactive. When the space becomes vacant, the green LED becomes active and the red LED turns inactive. The LEDs include a wireless adapter to obtain data packets from the network and display the space status accordingly.

In another implementation, traffic control inspectors or personnel may use the guidance information to control traffic flow to avoid congestion in parking facilities. They may obtain browser based views of occupancy information of the entire parking lot to direct the traffic towards underutilized parking zones. This is in addition to automated guidance provided by displays during peak traffic conditions on holidays or special events. Moreover, parking facilities management staff can obtain a macroscopic view of the parking activity in the entire parking facilities remotely at a monitoring console located in an office.

In one implementation, commuters may query a web based interface to search for available parking spaces in a particular locality or parking facility. The parking space occupancy information is processed to identify the available spaces and users are then made aware of these spaces.

Hardware Design of Display Nodes

Display nodes are electronic display devices that show message signs and include a wireless adapter to obtain data packets from the network. In an embodiment, the display device could be an off the shelf or custom LED display that fits the customer requirements. The LED displays may of different types. They could be for indoor or outdoor use. They may be dot matrix, segmented displays, or other types. The displays may have a different number of digits or display different languages. The type, size, and color of each character and sign may be different for displays located in different parts of the parking facility. The display nodes may be connected to a power outlet and installed at the entrance of parking lots and aisles such that they are easily visible to the incoming traffic. The displays may also be battery powered, solar powered, or powered by some alternative energy source.

Software Design of Display Nodes

In one implementation, software design of display nodes includes one primary software module. A data processing module combines event data from the network into appropriate guidance information. The display node maintains a list of source sensor nodes and updates their status as it receives new events. The data processing module computes the results and provides the information to the display controller to flash onto the display screen in the form of appropriate messages and symbols. The execution environment at display nodes is embedded Linux. To provide enhanced guidance information to visitors, the display performs intelligent transformation of information it receives from the network. In other implementations, the display node may contain more than one software module. The execution environment at the display nodes may be an environment other than embedded Linux, such as TinyOS, Linux, real-time operating systems (RTOSes), Mobilinux, and others.

Transformation

In one implementation, displays present cumulative counts of the aisle or a given parking zone by obtaining data events from source sensor nodes. The displays may intelligently transform the available parking space count when it reaches a threshold level to provide a more meaningful interpretation of the information presented to visitors. For example, if the available spaces are very few and the lot is close to fully occupied, the displays may present a text message indicating the lot is almost full. This message serves as a warning to incoming commuters about low probability of finding a vacant spot in the given lot or aisle. Thus, transformation of a numeric count to a warning or special message enhances the effectiveness of the overall application by providing more user-friendly communication to commuters.

Design of Administration and Management Tools

As described in a previous section, administration and management tools are essential to make sure the key system components, such as parking space monitoring, wireless networking, parking guidance, parking policy definition, violation, and detection as well as alert notification work properly throughout the lifetime of the system. Since the parking management system is an unattended and automated system, remote administration and management tools are necessary to obtain feedback from the system related to its performance and to discover maintenance tasks as soon as they arise.

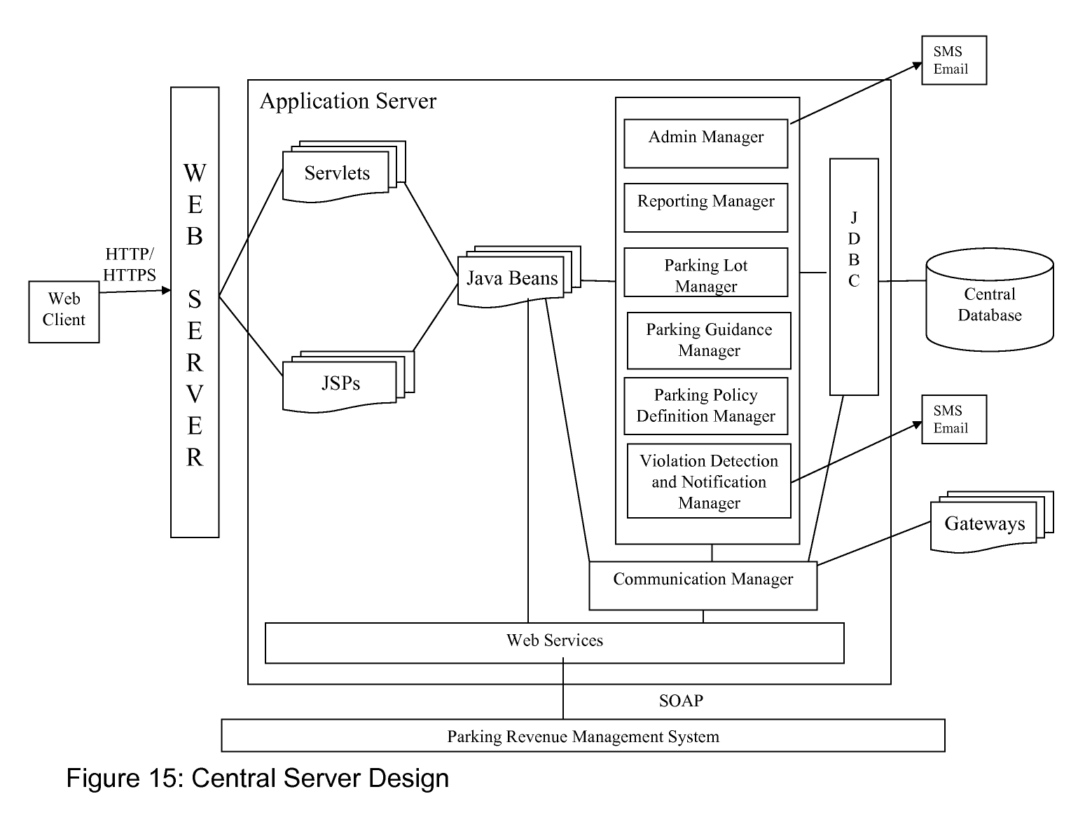

FIG. 15 shows the design of the central server. In one implementation, browser-based clients access the server either via a hypertext transfer protocol (HTTP/HTTPS) interface and third party integration clients access it via a simple object access protocol (SOAP) interface. In the case of browser based clients, individual web pages are implemented as front-end Java servlets or Java server pages (JSPs) and the session state is maintained within Java Beans. Additionally, the central server contains back-end elements called managers that process data and respond to client requests. The managers communicate with the central database via the Java database connectivity layer.

In one implementation, based on the client's request, a Java Bean interacts with an appropriate manager to cater to the request. The admin manager is responsible for system administration and network maintenance tasks such as sending administrative alerts, displaying the health of individual nodes, displaying the health of the network, and other tasks. The reporting manager displays real-time views of the parking lots as well as provides reports on historical data. The parking lot manager manages parking lot activities, such as when the parking facility is open or close. The parking guidance manager sets the messages to be shown on the displays, associates displays with parking spaces, and other tasks. the parking policy definition manager helps users define parking policies for the system to enforce. The violation detection and notification manager monitors parking activity in real-time, detects violations to parking policies, and raises violation alerts in real-time. The communication manager manages the communication between the server and gateway nodes.

In one implementation, the central server may also support a web services based application programming interface (API) to facilitate integration with third party systems. The third party systems include revenue management systems, reservation systems, enterprise portals, parking garage management systems, and other systems. These systems send and receive messages using the SOAP and typically interact with the server in an automated manner (i.e., no human involvement). In particular, the API may be used with revenue management systems to receive parking payment information (includes parking space identifier, amount paid, and valid duration of stay) as and when visitors make their payments. The payment information is used to enforce parking policies relating to paid parking as well as help generate reports to audit the revenue collected by the facility.

Network management is an important service carried out on the wireless network to obtain parameters related to individual node health and proper functioning of the sensor nodes, bridge nodes, display nodes, gateway nodes, and permit nodes. Alerting is a management tool to inform the administration staff about maintenance tasks or an impending failure of nodes or links. The administrators also perform the important duties of initializing and updating control parameters to monitor parking activities. Administrators have the flexibility to control the sensing interval, or discontinue monitoring in a particular parking lot if they need to temporarily reserve it for another activity and then resume normal parking monitoring in that lot later. They may customize messages sent over displays to notify visitors or navigate them in a certain direction to control traffic. Administrators have the flexibility to control parking operations by issuing commands to the wireless network that could reset the default software parameters at nodes to new values, for example, to modify the sensing frequency of sensor nodes.

Since network management data and administrative privileges are sensitive, security features have been designed to protect this information from intruders, and to ensure that only authorized personnel can access management data monitoring or administrative privileges.

Network Management

In one implementation, the network management service continuously monitors the network health, and facilitates administrators to take corrective operations to ensure that the network operations are not disrupted by frequent link failures or occasional node failures. Network health parameters include neighbor tables, child sensor node membership tables at the bridge nodes, residual energy levels, sensor health from the sensor nodes. Sensor, display and bridge nodes periodically send data related to the status of their various components such as battery, sensors or radio links to the central server.

In one implementation, a history of network health parameters is maintained at the central database to enable network maintenance and debugging tasks such as identifying and replacing nodes that have battery power less than a threshold level. Some nodes may show poor network connectivity due to physical obstacles and signal fading which could be handled by changing the orientation or physical position of the node or adding redundancy to the network. At other times, the sensor at the sensor node may be malfunctioning or poorly calibrated. A connectivity and node battery level graph is maintained at the central server which is continuously updated to obtain the latest view of network topology. Feedback on the average routing load at each bridge node during B2B frames could identify hot-spot or areas in the network topology experience network congestion.

Administrative Alerts

In any large scale distributed system, administrative alerts are an indispensable tool to notify the system administrators for anomalous situations such as malfunctioning nodes. All nodes carry out self diagnosis and report to a central server with information about their battery health or network connectivity condition. Nodes periodically send a probe to keep track of their neighbors' health or link quality. So, neighbors of the nodes not functioning properly may generate alerts for the system administrator based on their probe response. Other types of software alerts could be application specific. For example, if a vehicle such as a motorcycle is parked in a parking space meant for cars, suitable alerts may be raised by the sensors to notify the parking facility to take action during such situations. Additionally, if the sensor node continues to make anomalous readings that do not confirm the presence or the absence of a vehicle an alert is raised to notify the system administrator.

Security

In an implementation, it is essential to secure all data that is transmitted over the wireless network since the network is susceptible to snooping. The system uses encryption schemes to protect data from intruders. It is also important to verify that the packets are received from a valid network node and not from a malicious one. The system uses authentication and encryption mechanisms to protect the network from such security attacks. Additionally access privileges are assigned to authorize parking personnel who use the administrative or monitoring console to protect data from intruders.

This description of the invention has been presented for the purposes of illustration and description. It is not intended to be exhaustive or to limit the invention to the precise form described, and many modifications and variations are possible in light of the teaching above. The embodiments were chosen and described in order to best explain the principles of the invention and its practical applications. This description will enable others skilled in the art to best utilize and practice the invention in various embodiments and with various modifications as are suited to a particular use. The scope of the invention is defined by the following claims.

The invention claimed is:

1. A method comprising:
providing a plurality of parking spaces in a first parking area;
providing a plurality of sensors to detect whether each parking space in the first parking area is occupied or unoccupied;
providing a enforcement policy for each parking space in the first area; and
based on data received from the plurality of sensors, determining whether an enforcement policy of a parking space is violated.

2. The method of claim 1 further comprising:
when the enforcement policy if violated, sending a notification to a device.

3. The method of claim 2 wherein the device is a portable device which receives the notification wirelessly.

4. The method of claim 1 wherein the enforcement policy for each parking space may be different.

5. The method of claim 1 wherein a first enforcement policy for a first parking space is different from a second enforcement policy for a second parking space.

6. The method of claim 1 wherein multiple enforcement policies are associated with to a single parking space, and each policy is assigned a priority value.

7. The method of claim 6 wherein when two enforcement policies apply to a parking space, the enforcement policy with the higher priority value takes precedence over the enforcement policy with the lower priority value.

8. The method of claim 6 wherein when two enforcement policies apply to a parking space, the enforcement policy with the lower priority value takes precedence over the enforcement policy with the higher priority value.

9. The method of claim 1 further comprising:
specifying an enforcement policy for each parking space.

10. The method of claim 1 further comprising:
specifying an identical enforcement policy for two or more parking spaces.

11. The method of claim 1 wherein the plurality of sensors wirelessly transmit data regarding whether a parking space is occupied.

12. The method of claim 1 wherein the plurality of sensors comprise magnetic sensors to detect whether a parking space is occupied.

13. The method of claim 1 comprising:
providing an enforcement policy which is violated when a parking space is occupied for more than a specified elapsed time period.

14. The method of claim 1 comprising:
providing an enforcement policy which is violated when nonparking space area is occupied for more than a specified elapsed time period.

15. The method of claim 1 comprising:
providing an enforcement policy which is violated when two or more parking spaces are occupied by a single vehicle for more than a specified elapsed time period.

16. The method of claim 1 comprising:
providing an enforcement policy which is violated when a parking space is occupied during a prohibited time period.

17. The method of claim 1 comprising:
providing an enforcement policy which is violated when a parking space is occupied by a vehicle not having a permit node transmitting appropriate credentials.

18. The method of claim 1 comprising:
providing an enforcement policy which is violated when a parking space is occupied and a parking meter associated with the parking space has expired.

19. The method of claim 18 wherein the enforcement policy further comprises that the parking space is occupied during an enforcement time period of the parking meter.

20. The method of claim 1 further comprising:
when the enforcement policy if violated, charging a fee to account associated with the vehicle violating the enforcement policy.
